(19) United States
(12) Patent Application Publication
(10) Pub. No.: US 2023/0043452 A1
(43) Pub. Date: Feb. 9, 2023

(54) COMPOSITIONS COMPRISING CATIONIC POLY ALPHA-1,3-GLUCAN ETHERS

(71) Applicant: The Procter & Gamble Company, Cincinnati, OH (US)

(72) Inventors: Carola BARRERA, West Chester, OH (US); Mark Robert SIVIK, Mason, OH (US); Kristine Lynn FLITER, Harrison, OH (US); Helen S.M. LU, Wallingford, PA (US); Weiming QIU, Wilmongton, DE (US)

(21) Appl. No.: 17/958,719

(22) Filed: Oct. 3, 2022

Related U.S. Application Data
(63) Continuation of application No. PCT/US21/29538, filed on Apr. 28, 2021.

(30) Foreign Application Priority Data
May 5, 2020 (EP) EP20172973.8

(51) Int. Cl. C11D 3/20; C11D 3/30; C11D 1/82; C11D 1/46; C11D 11/00

(52) U.S. Cl. CPC C11D 3/2068; C11D 3/30; C11D 1/82; C11D 1/46; C11D 11/0017

(57) ABSTRACT

Fabric conditioning compositions that include a poly alpha-1,3-glucan ether compound and depositable actives, where the poly alpha-1,3-glucan ether compound may be characterized by certain molecular weights and degrees of cationic substitution. Related methods of using and making such compositions.

### FIELD OF THE INVENTION

The present disclosure relates to fabric conditioning compositions that include a poly alpha-1,3-glucan ether compound and depositable actives, where the poly alpha-1,3-glucan ether compound may be characterized by certain molecular weights and degrees of cationic substitution. The present disclosure further relates to methods of using and making such compositions.

### BACKGROUND OF THE INVENTION

Cationic polymers can be useful in household care compositions, such as fabric conditioning compositions, as they can facilitate improvements in conditioning benefits, which may include improved feel or freshness.

In particular, cationic polysaccharides may be preferred by manufacturers and/or consumers, as they are typically derived from natural sources or feedstocks and are therefore viewed as sustainable, environmentally friendly materials. However, certain cationic polysaccharides present processing or formulation challenges. For example, some may lead to undesirable viscosity increases, or may be incompatible with other ingredients, such as cellulase enzymes.

There is a continued need for improved fabric conditioning compositions that include cationically substituted polysaccharides.

### SUMMARY OF THE INVENTION

The present disclosure relates to fabric conditioning composition that include certain poly alpha-1,3-glucan ether compounds.

For example, the present disclosure relates to a fabric conditioning composition that includes: a poly alpha-1,3-glucan ether compound characterized by: (a) a weight average molecular weight of from about 90 kDaltons to about 350 kDaltons, and (b) a degree of cationic substitution of from about 0.15 to about 0.8; and a depositable conditioning active selected from a softening active, a freshness active, or a combination thereof.

The present disclosure also relates to a fabric conditioning composition that includes: a poly alpha-1,3-glucan ether compound, where the poly alpha-1,3-glucan ether compound has a degree of cationic substitution of about 0.15 to about 0.8, preferably from about 0.3 to about 0.7, or from about 0.3 to about 0.6, or from about 0.4 to about 0.6, or from about 0.4 to about 0.5, and where the poly alpha-1,3-glucan ether compound is derived from a polysaccharide backbone characterized by a weight average molecular weight of from about 90 kDaltons to about 190 kDaltons, as determined prior to substitution; and further including a depositable conditioning active selected from a softness active, a freshness active, or a combination thereof.

The present disclosure further relates to a fabric conditioning composition that includes: a poly alpha-1,3-glucan ether compound represented by the structure:

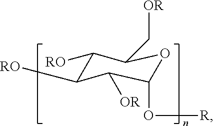

where (i) n is from about 425 to about 1200, preferably from about 500 to about 1100, or from about 600 to about 1050, or from about 700 to about 1000, or from about 700 to about 900, or from about 700 to about 800, (ii) each R is independently an H or a positively charged organic group, preferably where the positively charged organic group includes a substituted ammonium group, preferably a quaternary ammonium group, more preferably a trialkyl ammonium group, even more preferably a trimethylammonium group, and (iii) the compound has a degree of cationic substitution of about 0.15 to about 0.8, preferably from about 0.3 to about 0.7, or from about 0.3 to about 0.6, or from about 0.4 to about 0.6, or from about 0.4 to about 0.5; and further including a depositable conditioning active selected from a softness active, a freshness active, or a combination thereof.

The present disclosure also relates to a process of conditioning a fabric, where the process includes the steps of: contacting a fabric with a conditioning composition according to the present disclosure, optionally in the presence of water; and optionally rinsing the surface with water.

### DETAILED DESCRIPTION OF THE INVENTION

The present disclosure relates to fabric conditioning compositions that contain certain cationically substituted poly alpha-1,3-glucan ether compounds, a glucan polymer characterized by having alpha-1,3-glycosidic linkages. These compounds are polysaccharides, are generally cellulase-compatible, and may come in a wide range of molecular weights and degrees of substitution. Such cationic compounds have been disclosed as providing rheology or viscosity-modifying benefits.

That being said, it has surprisingly been found that selecting certain cationic poly alpha-1,3-glucan ether compounds can provide performance benefits in the context of fabric conditioning compositions. More specifically, it has been found that such compounds characterized by particular molecular weights and/or degrees of substitution can improve the performance on fabric of certain depositable actives, such as those that provide feel or freshness benefits.

The compositions, polymers contained therein, and related methods are discussed in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the phrase “fabric conditioning composition” includes compositions and formulations designed for treating fabric with a conditioning agent. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

The terms “poly alpha-1,3-glucan”, “alpha-1,3-glucan polymer,” “polyglucan,” and “glucan polymer” are used interchangeably herein. Poly alpha-1,3-glucan is a polymer comprising glucose monomeric units linked together by glycosidic linkages (i.e., glucosidic linkages), wherein at least about 50% of the glycosidic linkages are alpha-1,3-glycosidic linkages. Poly alpha-1,3-glucan is a type of polysaccharide. The general structure of a poly alpha-1,3-glucan can be illustrated as follows:

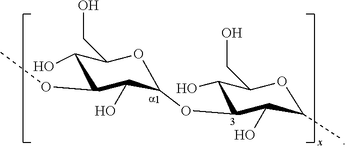

Poly alpha-1,3-glucan that can be used for preparing poly alpha-1,3-glucan ether compounds herein can be prepared using chemical methods. Alternatively, it can be prepared by extracting it from various organisms, such as fungi, that produce poly alpha-1,3-glucan. Alternatively still, poly alpha-1,3-glucan can be enzymatically produced from sucrose using one or more glucosyltransferase (gtf) enzymes (e.g., gtfJ), such as described in U.S. Pat. No. 7,000,000, and U.S. Patent Appl. Publ. Nos. 2013/0244288 and 2013/0244287 (all of which are incorporated herein by reference), for example.

The percentage of glycosidic linkages between the glucose monomer units of poly alpha-1,3-glucan used to prepare poly alpha-1,3-glucan ether compounds herein that are alpha-1,3 is at least about 50%, 60%, 70%, 80%, 90%, 95%, 96%, 97%, 98%, 99%, or 100% (or any integer value between 50% and 100%). In such embodiments, accordingly, poly alpha-1,3-glucan has less than about 50%, 40%, 30%, 20%, 10%, 5%, 4%, 3%, 2%, 1%, or 0% (or any integer value between 0% and 50%) of glycosidic linkages that are not alpha-1,3.

Poly alpha-1,3-glucan used to produce poly alpha-1,3-glucan ether compounds herein is preferably linear/unbranched. In certain embodiments, poly alpha-1,3-glucan has no branch points or less than about 10%, 9%, 8%, 7%, 6%, 5%, 4%, 3%, 2%, or 1% branch points as a percent of the glycosidic linkages in the polymer. Examples of branch points include alpha-1,6 branch points, such as those present in mutan polymer.

The terms “glycosidic linkage” and “glycosidic bond” are used interchangeably herein and refer to the type of covalent bond that joins a carbohydrate (sugar) molecule to another group such as another carbohydrate. The term “alpha-1,3-glycosidic linkage” as used herein refers to the type of covalent bond that joins alpha-D-glucose molecules to each other through carbons 1 and 3 on adjacent alpha-D-glucose rings. This linkage is illustrated in the poly alpha-1,3-glucan structure provided above. Herein, “alpha-D-glucose” will be referred to as “glucose”.

The terms “poly alpha-1,3-glucan ether compound”, “poly alpha-1,3-glucan ether”, and “poly alpha-1,3-glucan ether derivative” are used interchangeably herein. A poly alpha-1,3-glucan ether compound herein can be represented by the structure:

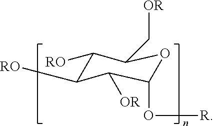

Regarding the formula of this structure, n can be from about 425 to about 1200, and each R can independently be a hydrogen atom (H) or a positively charged organic group. A poly alpha-1,3-glucan ether compound herein may have a degree of substitution of about 0.15 to about 0.8. Given that poly alpha-1,3-glucan ether compounds herein have one or more types of positively charged organic groups, these compounds can be considered “cationic”.

A “positively charged organic group” group as used herein refers to a chain of one or more carbons (“carbon chain”) that has one or more hydrogens substituted with another atom or functional group (i.e., a “substituted alkyl group”), where one or more of the substitutions is with a positively charged group. Where a positively charged organic group has a substitution in addition to a substitution with a positively charged group, such additional substitution may be with one or more hydroxyl groups, oxygen atoms (thereby forming an aldehyde or ketone group), alkyl groups, and/or additional positively charged groups. A positively charged organic group has a net positive charge since it comprises one or more positively charged groups.

The terms “positively charged group”, “positively charged ionic group” and “cationic group” are used interchangeably herein. A positively charged group comprises a cation (a positively charged ion). An example of positively charged groups includes substituted ammonium groups.

The terms “substituted ammonium group”, “substituted ammonium ion” and “substituted ammonium cation” are used interchangeably herein. A substituted ammonium group herein may comprise structure I:

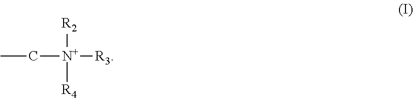

R₂, R₃ and R₄ in structure I may each independently represent a hydrogen atom or an alkyl, aryl, cycloalkyl, aralkyl, or alkaryl group. The carbon atom (C) in structure I is part of the chain of one or more carbons (“carbon chain”) of the positively charged organic group. The carbon atom is either directly ether-linked to a glucose monomer of poly alpha-1,3-glucan, or is part of a chain of two or more carbon atoms ether-linked to a glucose monomer of poly alpha-1,3-glucan. The carbon atom in structure I can be CH2, CH (where a H is substituted with another group such as a hydroxy group), or C (where both H's are substituted).

A substituted ammonium group can be a “primary ammonium group”, “secondary ammonium group”, “tertiary ammonium group”, or “quaternary ammonium” group, depending on the composition of R₂, R₃ and R₄ in structure I. A quaternary ammonium group is preferred herein and refers to structure I in which each of R₂, R₃ and R₄ is an alkyl, aryl, or cycloalkyl group (i.e., none of R₂, R₃ and R₄ is a hydrogen atom).

A quaternary ammonium poly alpha-1,3-glucan ether herein can comprise a trialkyl ammonium group (where each of R₂, R₃ and R₄ is an alkyl group), for example. A trimethylammonium group is an example of a trialkyl ammonium group, where each of R₂, R₃ and R₄ is a methyl group. It would be understood that a fourth member (i.e., R₁) implied by “quaternary” in this nomenclature is the chain of one or more carbons of the positively charged organic group that is ether-linked to a glucose monomer of poly alpha-1,3-glucan.

An example of a quaternary ammonium poly alpha-1,3-glucan ether compound is trimethylammonium hydroxypropyl poly alpha-1,3-glucan. The positively charged organic group of this ether compound can be represented as structure II:

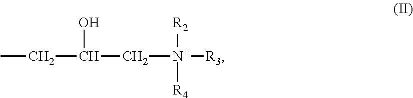

where each of R₂, R₃ and R₄ is a methyl group. Structure II is an example of a quaternary ammonium hydroxypropyl group.

In a group according to structure II, any one of R₂, R₃ and R₄ may be substituted with a C₁₂ alkyl, and the remaining R groups may be substituted with a methyl group.

The term “degree of substitution” (DoS) as used herein refers to the average number of hydroxyl groups substituted in each monomeric unit (glucose) of a poly alpha-1,3-glucan ether compound. Since there are three hydroxyl groups in each monomeric unit in poly alpha-1,3-glucan, the degree of substitution in a poly alpha-1,3-glucan ether compound herein can be no higher than 3.

The term “molar substitution” (M.S.) as used herein refers to the moles of a positively charged organic group per monomeric unit of a poly alpha-1,3-glucan ether compound. Alternatively, M.S. can refer to the average moles of etherification agent used to react with each monomeric unit in poly alpha-1,3-glucan (M.S. can thus describe the degree of derivatization of an etherification agent). It is noted that the M.S. value for poly alpha-1,3-glucan may have no upper limit. For example, when a positively charged organic group containing a hydroxyl group (e.g., hydroxyethyl or hydroxypropyl) has been etherified to poly alpha-1,3-glucan, the hydroxyl group of the organic group may undergo further reaction, thereby coupling more of the positively charged organic group to the poly alpha-1,3-glucan.

The term “crosslink” herein refers to a chemical bond, atom, or group of atoms that connects two adjacent atoms in one or more polymer molecules. It should be understood that, in a composition comprising crosslinked poly alpha-1,3-glucan ether, crosslinks can be between at least two poly alpha-1,3-glucan ether molecules (i.e., intermolecular crosslinks); there can also be intramolecular crosslinking. A “crosslinking agent” as used herein is an atom or compound that can create crosslinks.

An “aqueous composition” herein refers to a solution or mixture in which the solvent is at least about 20 wt % water, for example, and which comprises poly alpha-1,3-glucan and/or a poly alpha-1,3-glucan ether compound. Examples of aqueous compositions herein are aqueous solutions and hydrocolloids.

The terms “hydrocolloid” and “hydrogel” are used interchangeably herein. A hydrocolloid refers to a colloid system in which water is the dispersion medium. A “colloid” herein refers to a substance that is microscopically dispersed throughout another substance. Therefore, a hydrocolloid herein can also refer to a dispersion, emulsion, mixture, or solution of poly alpha-1,3-glucan and/or one or more poly alpha-1,3-glucan ether compounds in water or aqueous solution.

The term “aqueous solution” herein refers to a solution in which the solvent is water. Poly alpha-1,3-glucan and/or one or more poly alpha-1,3-glucan ether compounds herein can be dispersed, mixed, and/or dissolved in an aqueous solution. An aqueous solution can serve as the dispersion medium of a hydrocolloid herein.

The term “viscosity” as used herein refers to the measure of the extent to which a fluid or an aqueous composition such as a hydrocolloid resists a force tending to cause it to flow. Various units of viscosity that can be used herein include centipoise (cPs) and Pascal-second (Pa·s). A centipoise is one one-hundredth of a poise; one poise is equal to 0.100 kg·m⁻¹·s⁻¹. Thus, the terms “viscosity modifier” and “viscosity-modifying agent” as used herein refer to anything that can alter/modify the viscosity of a fluid or aqueous composition. Viscosity is determined according to the procedure provided in the Test Method section below.

The term “shear thinning behavior” as used herein refers to a decrease in the viscosity of the hydrocolloid or aqueous solution as shear rate increases. The term “shear thickening behavior” as used herein refers to an increase in the viscosity of the hydrocolloid or aqueous solution as shear rate increases. “Shear rate” herein refers to the rate at which a progressive shearing deformation is applied to the hydrocolloid or aqueous solution. A shearing deformation can be applied rotationally.

The terms “fabric”, “textile”, and “cloth” are used interchangeably herein to refer to a woven material having a network of natural and/or artificial fibers. Such fibers can be thread or yarn, for example.

The terms “heavy duty detergent” and “all-purpose detergent” are used interchangeably herein to refer to a detergent useful for regular washing of white and colored textiles at any temperature. The terms “low duty detergent” or “fine fabric detergent” are used interchangeably herein to refer to a detergent useful for the care of delicate fabrics such as viscose, wool, silk, microfiber or other fabric requiring special care. “Special care” can include conditions of using excess water, low agitation, and/or no bleach, for example.

The term “adsorption” herein refers to the adhesion of a compound (e.g., poly alpha-1,3-glucan ether) to the surface of a material.

The “molecular weight” of poly alpha-1,3-glucan and poly alpha-1,3-glucan ether compounds herein can be represented as number-average molecular weight (Mₙ) or as weight-average molecular weight (M_{w}). Alternatively, molecular weight can be represented as Daltons, grams/mole, DPw (weight average degree of polymerization), or DPn (number average degree of polymerization). Various means are known in the art for calculating these molecular weight measurements, such as high-pressure liquid chromatography (HPLC), size exclusion chromatography (SEC), or gel permeation chromatography (GPC). Size exclusion chromatography, as further described in the test methods section below, is used to determine the weight average molecular weight.

The terms “percent by volume”, “volume percent”, “vol %” and “v/v %” are used interchangeably herein. The percent by volume of a solute in a solution can be determined using the formula: [(volume of solute)/(volume of solution)]×100%.

The terms “percent by weight”, “weight percentage (wt %)” and “weight-weight percentage (% w/w)” are used interchangeably herein. Percent by weight refers to the percentage of a material on a mass basis as it is comprised in a composition, mixture or solution.

The terms “increased”, “enhanced” and “improved” are used interchangeably herein. These terms refer to a greater quantity or activity such as a quantity or activity slightly greater than the original quantity or activity, or a quantity or activity in large excess compared to the original quantity or activity, and including all quantities or activities in between. Alternatively, these terms may refer to, for example, a quantity or activity that is at least 1%, 2%, 3%, 4%, 5%, 6%, 7%, 8%, 9%, 10%, 20%, 30%, 40%, 50%, 60%, 70%, 80%, 90%, 100%, 125%, 150%, 175%, or 200% (or any integer between 1% and 200%) more than the quantity or activity for which the increased quantity or activity is being compared.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Fabric Conditioning Composition

The present disclosure relates to fabric conditioning compositions. The compositions may include a poly alpha-1,3-glucan ether compound and a depositable conditioning active.

Such compositions may provide softness, care, and/or freshness benefits to fabrics. The compositions may be intended to treat fabrics through the wash cycle and/or the rinse cycle of an automatic washing machine, preferably the rinse cycle.

The fabric conditioning compositions of the present disclosure may be in any suitable form. The composition may be in the form of a liquid composition, a granular composition, a single-compartment pouch, a multi-compartment pouch, a dissolvable sheet, a pastille or bead, a fibrous article (which may be water-soluble or water-dispersible, or substantially non-soluble/non-dispersible), a tablet, a bar, a flake, a foam/mousse, a non-woven sheet (e.g., a dryer sheet), or a mixture thereof. The composition can be selected from a liquid, solid, or combination thereof. The composition may be in the form of a liquid fabric enhancer, a foam/mousse, a dryer sheet, or a pastille/bead.

Such compositions may be used as a pre-laundering treatment, a post-laundering treatment, or may be added during the rinse or wash cycle of the laundering operation, or even during a drying process. Such compositions may be applied to a fabric in between usage of the fabric, such as between wearing of a garment.

The composition may be in the form of a liquid. The composition may include water. The composition may be aqueous. The composition, which may be a liquid composition, may comprise at least 50% by weight of water, preferably at least 75%, or even more than 85%, or even more than 90%, or even more than 95%, by weight of water. The composition may comprise from about 10% to about 97%, by weight of the composition, of water, preferably from about 10% to about 90%, more preferably from about 25% to about 80%, more preferably from about 45% to about 70%. The liquid composition may be a liquid fabric enhancer. The liquid may be packaged in a pourable bottle. The liquid may be packaged in an aerosol can or other spray bottle.

The composition may be a non-aqueous composition. The composition may comprise less than 20% water, or less than 15% water, or less than 12% water, or less than 10% water, or less than 8% water, or less than 5% water, or less than 3% water, or less than 1% water. Such compositions may be preferred so as to minimize the energy required to transport water, e.g., for environmental reasons. Such compositions may be liquids, gels, or solids (including granules or powders, and/or dissolvable sheets or webs).

The composition may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The composition may be in the form of a solid, preferably in the form of particles, such as a pastille or bead. Suitable particles may comprise the poly alpha-1,3-glucan ether compound dispersed in a water-soluble carrier. Individual particles may have a mass from about 1 mg to about 1 g. The water-soluble carrier may be a water-soluble polymer. The water-soluble carrier may be selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof. The composition may comprise from about 25% to about 99.99% by weight of the water-soluble carrier, and from about 0.01% to about 30% by weight of the poly alpha-1, 3-glucan ether compound. The particles may further comprise an additional benefit agent, such as perfume, a conditioning agent (e.g., a quaternary ammonium compound and/or a silicone), or mixtures thereof. The particles may be first particles and may be part of a plurality of particles that further comprise second particles. The plurality of particles may include first particles and second particles, where the particles that comprise the poly alpha-1,3-glucan ether compound are the first particles, and wherein the second particles comprise a different benefit agent, such as perfume, which may be unencapsulated perfume, encapsulated perfume, or a mixture thereof. The particles may be used in combination with a detergent composition, for example concurrently during a wash cycle, or subsequently during a rinse cycle.

The fabric care composition may have a viscosity of from 1 to 1500 centipoises (1-1500 mPa*s), or from 100 to 1000 centipoises (100-1000 mPa*s), or from 100 to 500 centipoises (100-500 mPa*s), or from 100 to 300 centipoises (100-300 mPa*s), or from 100 to 200 centipoises (100-200 mPa*s) at 20 s⁻¹ and 21° C. Viscosity is determined according to the Brookfield test method provided below. Relatively lower viscosities may be preferred to facilitate ease of dispensing and/or low machine residue.

The fabric care compositions of the present disclosure may be characterized by a pH of from about 2 to about 12, or from about 2 to about 8.5, or from about 2 to about 7, or from about 2 to about 5. The compositions of the present disclosure may have a pH of from about 2 to about 4, preferably a pH of from about 2 to about 3.7, more preferably a pH from about 2 to about 3.5, preferably in the form of an aqueous liquid. It is believed that such pH levels facilitate stability of the quaternary ammonium ester compound. The pH of a composition is determined by dissolving/dispersing the composition in deionized water to form a solution at 10% concentration, at about 20° C.

Certain components of the fabric conditioning compositions are described in more detail below.

### Poly Alpha-1,3-Glucan Ether Compound

The fabric conditioning compositions and methods of the present disclosure may comprise a poly alpha-1,3-glucan ether compound. Typically, the poly alpha-1,3-glucan ether compound is a poly alpha-1,3-glucan ether compound having a cationic charge. While such compounds are generally known to provide viscosity modification benefits to certain compositions, it has surprisingly been found that making particular selections of molecular weight and/or degree of substitution for a cationic poly alpha-1,3-glucan ether compound can provide improved performance benefits for certain fabric conditioning compositions, particularly those that further include a depositable benefit agent.

The fabric conditioning compositions of the present disclosure may comprise from about 0.01% to about 3%, or from about 0.05% to about 2.5%, or from about 0.1% to about 2%, or from about 0.2% to about 1.5%, or from about 0.2% to about 1%, or from about 0.2% to about 0.75%, or from about 0.2% to about 0.5%, by weight of the fabric conditioning composition, of the poly alpha-1,3-glucan ether compound.

The poly alpha-1,3-glucan ether compound may comprise from about 425 to about 1200 structural units having the following structure:

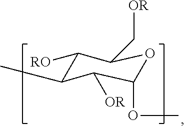

where each R is independently an H or a positively charged organic group. The poly alpha-1,3-glucan ether compound may comprise from about 500 to about 1100, or from about 600 to about 1050, or from about 700 to about 1000, or from about 700 to about 900, or from about 700 to about 800, repeats of the indicated structural unit. As indicated below, proper selection of the number of structural units (and thus, molecular weight) is desired to provide an effective conditioning composition. Each R is independently an H or a positively charged organic group, wherein the positively charged organic group may comprise a substituted ammonium group, preferably a quaternary ammonium group, more preferably a trialkyl ammonium group, even more preferably a trimethylammonium group. The poly alpha-1,3-glucan ether compound may comprise other structural units, including structural units that serve as branch points, although little-to-no branching is preferred.

The poly alpha-1,3-glucan ether compound may be represented by the structure:

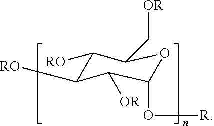

Regarding the formula of this structure, n can be from about 425 to about 1200, and each R in the compound may independently be an H or a positively charged organic group. Furthermore, the poly alpha-1,3-glucan ether compound may have a degree of substitution of about 0.15 to about 0.8.

The degree of substitution (DoS) of a poly alpha-1,3-glucan ether compound disclosed herein may be from about 0.15 to about 0.8, or from about 0.3 to about 0.7, or from about 0.3 to about 0.6, or from about 0.4 to about 0.6, or from about 0.4 to about 0.5. When the glucan ether compound is intended to be used in a through-the-wash application (e.g., as part of or in combination with a laundry detergent), the DoS may be from about 0.15 to about 0.6. When the glucan ether compound is intended to be used in a through-the-rinse application (e.g., as part of a liquid fabric enhancer), the DoS may be from about 0.3 to about 0.8. It would be understood by those skilled in the art that since a poly alpha-1,3-glucan ether compound herein has a degree of substitution between about 0.15 to about 0.8, and by virtue of being an ether, the R groups of the compound cannot only be hydrogen.

The percentage of glycosidic linkages between the glucose monomer units of poly alpha-1,3-glucan ether compounds herein that are alpha-1,3 is at least about 50%, 60%, 70%, 80%, 90%, 95%, 96%, 97%, 98%, 99%, or 100% (or any integer between 50% and 100%). In such embodiments, accordingly, the compound has less than about 50%, 40%, 30%, 20%, 10%, 5%, 4%, 3%, 2%, 1%, or 0% (or any integer value between 0% and 50%) of glycosidic linkages that are not alpha-1,3.

The backbone of a poly alpha-1,3-glucan ether compound herein is preferably substantially linear/unbranched. For example, the compound may have no branch points or fewer than about 10%, 9%, 8%, 7%, 6%, 5%, 4%, 3%, 2%, or 1% branch points as a percent of the glycosidic linkages in the polymer. Examples of branch points include alpha-1,6 branch points. It is believed that having relatively few branch points results in a relatively more-water-soluble polymer, which can facilitate ease of formulation.

For poly alpha-1,3-glucan ether compounds described above, the index n may be from about 425 to about 1200, or from about 500 to about 1100, or from about 600 to about 1050, or from about 600 to about 1000, or from about 700 to about 1000, or from about 700 to about 900, or from about 700 to about 800. It is believed that proper selection of the size of the molecule (which impacts the weight average molecular weight) is important to facilitate improved conditioning active performance and the conditioning compounds that contain them. For example, if the size of the molecule is too small, conditioning actives may not be adequately deposited; if the size of the molecule is too large, viscosity of the composition may be negatively impacted, for example by becoming too viscous.

The molecular weight of a poly alpha-1,3-glucan ether compound herein can be measured as weight-average molecular weight (M_{w}). Weight average molecular weight is determined by size exclusion chromatography (SEC), as described in more detail in the Test Methods section. The poly alpha-1,3-glucan ether compound herein may be characterized by a weight average molecular weight (M_{w}) of from about 90 kDaltons to about 350 kDaltons, or from about 90 to about 300 kDaltons, or from about 90 kDaltons to about 260 kDaltons, or from about 90 to about 240 kDaltons, or from about 95 to about 200 kDaltons, or from about 100 to about 175 kDaltons, or from about 100 to about 150 kDaltons, which is most preferred.

The poly alpha-1,3-glucan ether compound herein may be derived from a polysaccharide backbone characterized by a weight average molecular weight of from about 90 kDaltons to about 190 kDaltons, as determined prior to substitution. For a linear polymer of about 120 kdaltons, the number of repeat units is 740. This poly dispersity can range between 1 to about 5 and more preferably 1 to about 3.

Each R group in the formula of a poly alpha-1,3-glucan ether compound herein can independently be an H or a positively charged organic group. As defined above, a positively charged organic group comprises a chain of one or more carbons having one or more hydrogens substituted with another atom or functional group, where one or more of the substitutions is with a positively charged group.

A positively charged group may be a substituted ammonium group, for example. Examples of substituted ammonium groups are primary, secondary, tertiary and quaternary ammonium groups. Structure I, as described above, depicts a primary, secondary, tertiary or quaternary ammonium group, depending on the composition of R₂, R₃ and R₄ in structure I. Each of R₂, R₃ and R₄ in structure I independently represent a hydrogen atom or an alkyl, aryl, cycloalkyl, aralkyl, or alkaryl group. Alternatively, each of R₂, R₃ and R₄ in can independently represent a hydrogen atom or an alkyl group. An alkyl group herein can be a methyl, ethyl, propyl, butyl, pentyl, hexyl, heptyl, octyl, nonyl, or decyl group, for example. Where two or three of R₂, R₃ and R₄ are an alkyl group, they can be the same or different alkyl groups.

Quaternary ammonium poly alpha-1,3-glucan ether compounds are preferred. A “quaternary ammonium poly alpha-1,3-glucan ether compound” herein can comprise a positively charged organic group having a trialkylammonium group, for example. In this example, the positively charged organic group comprises structure I in which each of R₂, R₃ and R₄ is an alkyl group. A non-limiting example of such a positively charged organic group is represented by structure II when each of R₂, R₃ and R₄ is an alkyl group. An example of a quaternary ammonium poly alpha-1,3-glucan ether compound can be represented in shorthand as trialkylammonium poly alpha-1,3-glucan ether (e.g., trimethyl-, triethyl-, tripropyl-, tributyl-, tripentyl-, trihexyl-, triheptyl-, trioctyl-, trinonyl- or tridecyl-ammonium poly alpha-1,3-glucan ether). It would be understood that a fourth member (i.e., R₁) implied by “quaternary” in the above nomenclature is the chain of one or more carbons of the positively charged organic group that is ether-linked to a glucose monomer of poly alpha-1,3-glucan.

Although quaternary compounds are preferred, the compositions of the present disclosure may include primary, secondary, and/or tertiary ammonium poly alpha-1,3-glucan ether compounds, for example as impurities and/or partially reacted reaction products.

Additional non-limiting examples of substituted ammonium groups that can serve as a positively charged group herein are represented in structure I when each of R₂, R₃ and R₄ independently represent a hydrogen atom; an alkyl group such as a methyl, ethyl, or propyl group; an aryl group such as a phenyl or naphthyl group; an aralkyl group such as a benzyl group; an alkaryl group; or a cycloalkyl group. Each of R₂, R₃ and R₄ may further comprise an amino group or a hydroxyl group, for example.

The nitrogen atom in a substituted ammonium group represented by structure I is bonded to a chain of one or more carbons as comprised in a positively charged organic group. This chain of one or more carbons (“carbon chain”) is ether-linked to a glucose monomer of poly alpha-1,3-glucan, and may have one or more substitutions in addition to the substitution with the nitrogen atom of the substituted ammonium group. There can be 1, 2, 3, 4, 5, 6, 7, 8, 9, 10, 11, 12, 13, or 14 carbons, for example, in a carbon chain herein. To illustrate, the carbon chain of structure II is 3 carbon atoms in length.

Where a carbon chain of a positively charged organic group has a substitution in addition to a substitution with a positively charged group, such additional substitution may be with one or more hydroxyl groups, oxygen atoms (thereby forming an aldehyde or ketone group), alkyl groups (e.g., methyl, ethyl, propyl, butyl), and/or additional positively charged groups. A positively charged group is typically bonded to the terminal carbon atom of the carbon chain. The carbon chain may include one or more substitutions that include a hydroxyl group, preferably a hydroxyalkyl group, more preferably a hydroxypropyl group.

Poly alpha-1,3-glucan ether compounds in certain embodiments disclosed herein may contain one type of positively charged organic group as an R group. For example, one or more positively charged organic groups ether-linked to the glucose monomer of poly alpha-1,3-glucan may be trimethylammonium hydroxypropyl groups (structure II); the R groups in this particular example would thus independently be hydrogen and trimethylammonium hydroxypropyl groups.

Alternatively, poly alpha-1,3-glucan ether compounds disclosed herein can contain two or more different types of positively charged organic groups as R groups.

Poly alpha-1,3-glucan ether compounds herein can comprise at least one nonionic organic group and at least one anionic group, for example. As another example, poly alpha-1,3-glucan ether compounds herein can comprise at least one nonionic organic group and at least one positively charged organic group.

Poly alpha-1,3 glucan and/or poly alpha-1,3-glucan ethers herein are mostly or completely stable (resistant) to being degraded by cellulase enzymes. For example, the percent degradation of a poly alpha-1,3 glucan and/or poly alpha-1,3-glucan ether compound by one or more cellulases is less than 10%, 9%, 8%, 7%, 6%, 5%, 4%, 3%, 2%, or 1%, or is 0%. Such percent degradation can be determined, for example, by comparing the molecular weight of polymer before and after treatment with a cellulase for a period of time (e.g., —24 hours). Advantageously, such compounds may be co-formulated with cellulase, used concurrently with cellulase-containing products, or sequentially with such products where residual cellulase may remain on a surface and/or in an aqueous environment.

The poly alpha-1,3-glucan ether disclosed herein comprise a backbone of poly alpha-1,3-glucan randomly substituted with ether modifications along the polysaccharide backbone, such that the polysaccharide backbone comprises unsubstituted and substituted alpha-D-glucose rings. In embodiments wherein branches exist, the alpha-D-glucose rings of the branches may also be randomly substituted with ether modification groups. As used herein, the term “randomly substituted” means the substituents on the glucose rings in the randomly substituted polysaccharide occur in a non-repeating or random fashion. That is, the substitution on a substituted glucose ring may be the same or different [i.e. the substituents (which may be the same or different) on different atoms in the glucose rings in the polysaccharide] from the substitution on a second substituted glucose ring in the polysaccharide, such that the overall substitution on the polymer has no pattern. Further, the substituted glucose rings occur randomly within the polysaccharide (i.e., there is no pattern with the substituted and unsubstituted glucose rings within the polysaccharide).

Depend on the reaction conditions, it is also possible that the poly alpha-1,3-glucan ether compound disclosed herein comprise a backbone of poly alpha-1,3-glucan “non-randomly” substituted with ether modification groups along the polysaccharide backbone. In the situation where branches exist, it is possible the alpha-D-glucose rings of the branches could disproportionally contain more substitution than the backbone glucose monomer units which linked via alpha-1,3-glycosidic linkages. It is also possible that in certain reaction conditions the modification may exist in a block manner within the polysaccharide.

Depending on the reaction conditions, it is also possible that glucose carbon positions 1, 2, 3, 4, and 6 of the poly alpha-1,3-glucan backbone are “disproportionally” substituted. For example, the —OH group at carbon position 6 is a primary hydroxyl group and may exist in an environment which have less steric hindrance; therefore, this —OH group may have higher reactivity in certain reaction conditions, and thus, more substitution may happen at this position. In other reaction conditions, it may be possible that the —OH group at carbon position 1, 2, 3, or 4 have higher reactivity.

### Depositable Conditioning Active

The fabric conditioning compositions may further comprise a depositable conditioning active. A depositable conditioning active is an ingredient intended to be deposited onto a target surface, typically a fabric, with the intent that the ingredient remains on the target surface for at least some period of time following a treatment cycle, for example, after a garment has been washed and/or dried.

The depositable conditioning active may be a softening active, a freshness active, or a mixture thereof. It may be preferred that the depositable conditioning active is useful in the context of a fabric enhancing composition, preferably a liquid fabric enhancing composition.

The depositable active may be present at a level of from about 0.1% to about 35%, or from about 0.1% to about 25%, by weight of the fabric conditioning composition. When the depositable active is a softening active, the softening active may be present at a level of from about 2% to about 35%, or from about 2% to about 20%, or from about 2% to about 12%, or from about 2% to about 8%. When the depositable active is a freshness active, the freshness active may be present at a level of from about 0.1% to about 10%, or from about 0.2% to about 5%, or from about 0.3% to about 3%.

Softening Actives

The fabric conditioning compositions of the present disclosure may comprise a softening active. Softening actives may provide softness, anti-wrinkle, anti-static, conditioning, anti-stretch, color, and/or appearance benefits to target fabrics. The softening active may be selected from the group consisting of quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

The composition may include a quaternary ammonium ester compound, a silicone, or combinations thereof, preferably a combination. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

The compositions of the present disclosure may comprise a quaternary ammonium ester compound as a softening active. The quaternary ammonium ester compound (sometimes referred to as “ester quats”) may be present at a level of from about 2% to about 40%, or from about 3% to about 25%, preferably from 4% to 18%, more preferably from 5% to 15%, by weight of the composition. Preferably, the iodine value (see Methods) of the parent fatty acid from which the quaternary ammonium fabric compound is formed is from 0 to about 90, or from about 10 to about 70, or from about 15 to about 50, or from about 18 to about 30. The iodine value may be from about 25 to 50, preferably from 30 to 48, more preferably from 32 to 45. Without being bound by theory, lower melting points resulting in easier processability of the softening active are obtained when the parent fatty acid from which the quaternary ammonium compound is formed is at least partially unsaturated. In particular, double unsaturated fatty acids enable easy-to-process softening actives. In preferred liquid fabric softener compositions, the parent fatty acid from which the quaternary ammonium conditioning actives is formed comprises from 2.0% to 20.0%, preferably from 3.0% to 15.0%, more preferably from 4.0% to 15.0% of double unsaturated C18 chains (“C18:2”) by weight of total fatty acid chains (see Methods). On the other hand, very high levels of unsaturated fatty acid chains are to be avoided to minimize malodour formation as a result of oxidation of the fabric softener composition over time.

The quaternary ammonium ester compound may be present at a level of from greater than 0% to about 30%, or from about 1% to about 25%, or from about 3% to about 20%, or from about 4.0% to 18%, more preferably from 4.5% to 15%, even more preferably from 5.0% to 12% by weight of the composition. The level of quaternary ammonium ester compound may depend of the desired concentration of total fabric conditioning active in the composition (diluted or concentrated composition) and of the presence or not of other softening actives. However, the risk on increasing viscosities over time is typically higher in fabric treatment compositions with higher softening active levels. On the other hand, at very high softening active levels, the viscosity may no longer be sufficiently controlled which renders the product unfit for use.

Suitable quaternary ammonium ester compounds include but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester compound.

The quaternary ammonium ester compound may comprise compounds of the following formula:

{R²₍₄₋ₘ₎—N+-[X—Y—R¹]ₘ}A⁻

wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂-C₃ alkoxy), polyethoxy, benzyl;
each X is independently —(CH₂)n-, —CH₂—CH(CH₃)— or —CH—(CH₃)—CH₂— and each n is independently 1, 2, 3 or 4, preferably each n is 2;
each Y is independently —O—(O)C— or —C(O)—O—;
A− is independently selected from the group consisting of chloride, methyl sulfate, and ethyl sulfate, preferably A⁻ is selected from the group consisting of chloride and methyl sulfate, more preferably A− is methyl sulfate;
   with the proviso that when Y is —O—(O)C—, the sum of carbons in each R¹ is from 13 to 21, preferably from 13 to 19. Preferably, X is —CH₂—CH(CH₃)— or —CH—(CH₃)—CH₂— to improve the hydrolytic stability of the quaternary ammonium ester compound, and hence further improve the stability of the fabric treatment composition.

Examples of suitable quaternary ammonium ester compounds are commercially available from Evonik under the tradename Rewoquat WE18, and/or Rewoquat WE20, and/or from Stepan under the tradename Stepantex GA90, Stepantex VK90, and/or Stepantex VL90A.

The fabric conditioning compositions of the present disclosure may comprise silicone as a softening active. Suitable levels of silicone may comprise from about 0.1% to about 70%, or from about 0.3% to about 40%, or from about 0.5% to about 30%, alternatively from about 1% to about 20% by weight of the composition.

Useful silicones can be any suitable silicone-comprising compound. The silicone polymer may be selected from the group consisting of cyclic silicones, polydimethylsiloxanes, aminosilicones, cationic silicones, silicone polyethers, silicone resins, silicone urethanes, and mixtures thereof. The silicone may comprise a polydialkylsilicone, such as a polydimethyl silicone (polydimethyl siloxane or “PDMS”), or a derivative thereof. The silicone may comprise an aminofunctional silicone, amino-polyether silicone, alkyloxylated silicone, cationic silicone, ethoxylated silicone, propoxylated silicone, ethoxylated/propoxylated silicone, quaternary silicone, or combinations thereof. The silicone may comprise a polydimethyl silicone, an aminosilicone, or a combination thereof, preferably an aminosilicone.

The silicone may comprise a random or blocky organosilicone polymer. The silicone may be provided as an emulsion.

The silicone may be characterized by a relatively high molecular weight. A suitable way to describe the molecular weight of a silicone includes describing its viscosity. A high molecular weight silicone may be one having a viscosity of from about 10 cSt to about 3,000,000 cSt, or from about 100 cSt to about 1,000,000 cSt, or from about 1,000 cSt to about 600,000 cSt, or even from about 6,000 cSt to about 300,000 cSt.

The composition may comprise glyceride copolymers. The glyceride copolymers may be derived from natural oils. Examples of natural oils include, but are not limited to, vegetable oils, algae oils, fish oils, animal fats, tall oils, derivatives of these oils, combinations of any of these oils, and the like. Representative non-limiting examples of vegetable oils include low erucic acid rapeseed oil (canola oil), high erucic acid rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil, preferably canola oil. Representative non-limiting examples of animal fats include lard, tallow, poultry fat, yellow grease, and fish oil. Tall oils are by-products of wood pulp manufacture. The glyceride copolymers may be metathesized unsaturated polyol esters.

Freshness Actives

The fabric conditioning compositions of the present disclosure may comprise a freshness active. Freshness actives may provide aromatic (e.g., perfume) benefits and/or malodor reduction or malodor control benefits. The freshness actives may deliver the intended benefits at one or more consumer touchpoints, including in neat product, in a treatment liquor, on wet fabric, on dry fabric, or on rubbed fabric. The freshness active may be selected from fragrance actives, malodor control agents, or combinations thereof.

The freshness active may be a fragrance active. The fragrance active may be selected from free perfume, a perfume delivery system, a pro-perfume, or mixtures thereof.

The fragrance actives may comprise one or more perfume raw materials. The term “perfume raw material” (or “PRM”) as used herein refers to compounds having a molecular weight of at least about 100 g/mol and which are useful in imparting an odor, fragrance, essence, or scent, either alone or with other perfume raw materials. Typical PRMs comprise inter alia alcohols, ketones, aldehydes, esters, ethers, nitrites, and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994). The composition may comprise from about 0.05% to about 20%, or from about 0.1% to about 10%, or from about 0.1% to about 5%, by weight of the composition, of perfume raw materials, and the level of freshness active may be selected accordingly.

The fragrance active may comprise free perfume, where, e.g., perfume raw materials are not encapsulated or chemically bound to other components. Free perfume may be added to a base composition neat, or as an emulsion and/or in combination with solubilizers, which can facilitate adequate dispersion or stability in the composition.

The fragrance active may comprise a perfume delivery system. Suitable perfume delivery systems, methods of making certain perfume delivery systems, and the uses of such perfume delivery systems are disclosed in USPA 2007/0275866 A1. Perfume delivery systems may include Polymer Assisted Delivery (PAD) (including matrix systems or reservoir systems, such as encapsulates), Molecule-Assisted Delivery (MAD), Amine-Assisted Delivery (AAD), a Cyclodextrin Delivery System (CD), Starch Encapsulated Accords (SEA), an Inorganic Carrier Delivery System (ZIC), or mixtures thereof.

The fabric conditioning compositions of the present disclosure comprise encapsulates as a perfume delivery system. As more than one encapsulate is typically present, the compositions may be described as comprising a plurality or population of encapsulates.

The composition may comprise from about 0.05% to about 20%, or from about 0.05% to about 10%, or from about 0.1% to about 5%, or from about 0.2% to about 2%, by weight of the composition, of encapsulates. The composition may comprise a sufficient amount of encapsulates to provide from about 0.05% to about 10%, or from about 0.1% to about 5%, or from about 0.1% to about 2%, by weight of the composition, of perfume to the composition. When discussing herein the amount or weight percentage of the encapsulates, it is meant the sum of the shell material and the core material.

The encapsulates may have a volume weighted median encapsulate size from about 0.5 microns to about 100 microns, or even 10 to 100 microns, preferably from about 1 micron to about 60 microns, or even 10 microns to 50 microns, or even 20 microns to 45 microns, or alternatively 20 microns to 60 microns.

The encapsulates typically have a wall (or shell) that at least partially surrounds the core. may have a wall, which may at least partially surround the core. The core may include perfume raw materials and optionally a partitioning modifier, such as isopropyl myristate or other suitable material.

The wall may include a wall material selected from the group consisting of polyethylenes; polyamides; polystyrenes; polyisoprenes; polycarbonates; polyesters; polyacrylates; acrylics; aminoplasts; polyolefins; polysaccharides, such as alginate and/or chitosan; gelatin; shellac; epoxy resins; vinyl polymers; water insoluble inorganics; silicone; and mixtures thereof. The wall material may comprise a material selected from aminoplasts, polyurethanes, polyureas, polyacrylates, or mixtures thereof.

The outer wall of the encapsulate may include a coating. Certain coatings may improve deposition of the encapsulate onto a target surface, such as a fabric. The coating may comprise an efficiency polymer. The coating may comprise a cationic efficiency polymer. The cationic polymer may be selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, polyvinyl amines, polyvinyl formamides, pollyallyl amines, copolymers thereof, and mixtures thereof. The coating may comprise a polymer selected from the group consisting of polysaccharides (such as chitosan), polyvinyl amines, polyvinyl formamides, polyallyl amines, copolymers thereof, and mixtures thereof.

The encapsulate may comprise a wall that includes aminoplast material and a coating that includes polyvinyl formamide. The encapsulate may comprise a wall that includes polyacrylate material and a coating that includes chitosan.

The composition may be a fabric enhancer composition that comprises perfume encapsulates, preferably where the composition is a liquid. The composition may be a detergent composition, preferably a liquid detergent composition (optionally contained in a water-soluble pouch), that includes: perfume encapsulates; from about 5% to about 50%, preferably from about 8% to about 40%, of anionic surfactant that is preferably selected from linear alkyl benzene sulphonate, alkyl sulfate, and/or alkoxylated alkyl sulfate such as AES; and a cationic poly alpha-1,3-glucan ether compound according to the present disclosure.

The fragrance active may comprise a pro-perfume, which typically comprise a perfume raw material and a substantivity or solubility component; the perfume raw material and substantivity or solubility component are typically bonded, complexed, or otherwise coupled together. Over time or other triggering stimulus (e.g., contact with water, a change in pH, or an elevated temperature), the PRM and the component are decoupled, and the PRM is released in a protracted manner. By selecting a proper substantivity or solubility component, the formulated can control the solubility of the pro-perfume in water, the degree of substantivity of the pro-perfume for fabric, or the bulk properties of the material.

For example, once the laundry process is complete and the pro-perfume has been suitably delivered to the fabric, the pro-fragrance begins to release the perfume raw material, and because this release of material is protracted, the fabric remains “fresh-” and “clean-” smelling longer.

Suitable pro-perfumes may include dimethoxybenzoin derivatives and/or amine reaction products.

The freshness active may be a malodor control agent. The malodor control agent may comprise oligoamines. Certain oligoamines may contribute to the inhibition of the breakdown of certain compounds that may otherwise oxidize into malodorous compounds.

Suitable oligoamines according to the present disclosure may include diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me2TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, or mixtures thereof.

The oligoamine may preferably be selected from diethylenetriamine (DETA), 4-methyl diethylenetriamine (4-MeDETA), 1,1,4,7,7-pentamethyl diethylenetriamine (M5-DETA), dipropylenetriamine (DPTA), 5-methyl dipropylenetriamine (5-MeDPTA), triethylenetetramine (TETA), tripropylenetetraamine (TPTA), tetraethylenepentaamine (TEPA), tetrapropylenepentaamine (TPTA), N,N′-Bis(3-aminopropyl)ethylenediamine, and mixtures thereof, more preferably diethylenetriamine (DETA), 4-methyl diethylenetriamine (4-MeDETA), 1,1,4,7,7-pentamethyl diethylenetriamine (M5-DETA), triethylenetetramine (TETA), tetraethylenepentaamine (TEPA), N,N′-Bis(3-aminopropyl)ethylenediamine, and mixtures thereof, even more preferably diethylenetriamine (DETA), 4-methyl diethylenetriamine (4-MeDETA), N,N′-Bis(3-aminopropyl)ethylenediamine, and mixtures thereof, most preferably diethylenetriamine (DETA). DETA may be most preferred due to its low molecular weight and/or relatively low cost to produce.

### Other Adjuncts

The fabric conditioning compositions of the present disclosure may comprise other adjunct ingredients. The adjunct ingredients may be selected to provide, for example, processing, stability, and/or performance benefits.

Suitable consumer product adjunct materials may include: surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, structurants, anti-agglomeration agents, coatings, formaldehyde scavengers, and/or pigments.

Depending on the intended form, formulation, and/or end-use, compositions of the present disclosure or may not may not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids, structurants, anti-agglomeration agents, coatings, formaldehyde scavengers and/or pigments.

The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

Rheology Modifier/Structurant

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as the encapsulates as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon Inc. under the tradename Carbopol Aqua 30. Another suitable structurant is sold under the tradename Rheovis CDE, available from BASF.

Additional Cationic Polymer

The compositions of the present disclosure may comprise a cationic polymer in addition to the cationically substituted polyether glucans (and a cationic fabric softening active, if present) described above. Cationic polymers may serve as deposition aids, e.g., facilitating improved deposition efficiency of softening and/or freshness actives onto a target surface. Additionally or alternatively, additional cationic polymers may provide stability, structuring, and/or rheology benefits to the composition.

The composition may comprise, by weight of the composition, from 0.0001% to 3%, preferably from 0.0005% to 2%, more preferably from 0.001% to 1%, or from about 0.01% to about 0.5%, or from about 0.05% to about 0.3%, of an additional cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The cationic polymer may comprise a cationic polysaccharide, such as cationic starch, cationic cellulose, cationic guar, cationic chitosan, or mixtures thereof. The cationic cellulose may comprise a quaternized hydroxyethyl cellulose, preferably a hydroxyethyl cellulose derivatized with trimethyl ammonium substituted epoxide. Polymers derived from polysaccharides may be preferred, being naturally derived and/or sustainable materials. For clarity, the cationic polysaccharide as described herein, if present, is in addition to the cationically substituted poly alpha-1,3-glucan ether compounds described herein.

The cationic polymer may comprise a cationic acrylate. The cationic polymer may comprise cationic monomers, nonionic monomers, and optionally anionic monomers (so long as the overall charge of the polymer is still cationic). The cationic polymer, preferably the cationic acrylate, may comprise cationic monomers selected from the group consisting of methyl chloride quaternized dimethyl aminoethylammonium acrylate, methyl chloride quaternized dimethyl aminoethylammonium methacrylate and mixtures thereof. The cationic polymer, preferably the cationic acrylate, may comprise nonionic monomers selected from the group consisting of acrylamide, dimethyl acrylamide and mixtures thereof. The cationic polymer may optionally comprise anionic monomers selected from acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS), and their salts.

The cationic polymer, preferably the cationic acrylate polymer, may be substantially linear or may be cross-linked. The composition may comprise a polymer system, preferably a cationic acrylate polymer system, that comprises both a substantially linear cationic polymer (e.g., formed with less than 50 ppm cross-linking agent) and a cross-linked cationic polymer (e.g., formed with greater than 50 ppm cross-linking agent). Such combinations may provide both deposition and structuring benefits.

Surfactant

The fabric conditioning composition may include less than 5%, or less than 2%, or less than 1%, or less than about 0.1%, by weight of the composition, of anionic surfactant, or even be substantially free of anionic surfactant. Anionic surfactants can negatively impact the stability and/or performance of the present compositions, as they may undesirably interact with the cationic components. Compositions intended to be added during the rinse cycle of an automatic washing machine, such as a liquid fabric enhancer, may include relatively low levels of anionic surfactant. Additionally or alternatively, compositions intended to be used in combination with a detergent composition during the wash cycle of an automatic washing machine may include relatively low levels of anionic surfactant.

That being said, the compositions of the present disclosure may include detersive surfactants, depending on intended usage. Additionally, the compositions may include low levels of surfactants as emulsifying agents or other processing aids. For example, the compositions may include anionic surfactant, nonionic surfactant, zwitterionic surfactant, amphoteric surfactants, or mixtures thereof. Suitable anionic surfactants may include sulphonates, sulfates, or carboxylates, such as linear alkyl benzene sulphonate (LAS), alkyl sulfate, and/or alkoxylated alkyl sulfate (such as alkyl ethoxylated sulfate, or AES). Nonionic surfactants may include alkoxylated fatty alcohols, such as ethoxylated alkyl alcohols, alkyl polyglucosides, and/or nonionic surfactants based on Guerbet alcohols. Zwitterionic surfactants may include amine oxide surfactants. Amphoteric surfactants may include betaine surfactants.

Method of Making a Fabric Conditioning Composition

The present disclosure relates to processes for making any of the compositions described herein. The process of making a fabric conditioning composition may comprise the step of combining a poly alpha-1,3-glucan ether compound, as described herein, with a fabric conditioning active, as described herein.

The fabric conditioning compositions of the present disclosure can be formulated into any suitable form and prepared by any process chosen by the formulator. The poly alpha-1,3-glucan ether compounds, fabric conditioning actives, and/or adjunct materials may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders.

It may be desirable to provide the poly alpha-1,3-glucan ether compounds as a polymer premix. The premix may comprise, consist essentially of, or even consist of the poly alpha-1,3-glucan ether compound (e.g., 7.5 wt %) and water. The glucan polymer may be present in the premix at a level of about 5% to about 20%, preferably from about 5% to about 10% by weight of the premix. The glucan polymer and water may be present in a polymer:water weight ratio of from about 5:95 to 20:80, or from about 5:95 to about 10:90, or about 7.5:92.5. In order to optimize the polymer pre-mix, the polymer may be prepared with controlled mixing, sheer, and time in order for the resulting particles to be consistent in size and shape, as well as for the glucan polymer to become fully hydrated and to control the gel phase. Upon completion of hydration and prior to addition to a base product formulation, the polymer premix may be re-mixed (e.g., with an electronic roller or overhead mixer) in order to assure uniform fluidity in case of uneven gel formation. Use of a consistent protocol can decrease variations in formulation stability as well as minimize inconsistent performance that may result from varying concentrations of the polymer premix throughout the finished product.

The fabric conditioning composition may be encapsulated in water-soluble film(s) according to known methods to form a unitized dose article.

The fabric conditioning composition may be placed into an aerosol or other spray container according to known methods.

### Method of Using a Fabric Conditioning Composition

The present disclosure further relates to methods of using a fabric conditioning composition. For example, the present disclosure relates to methods of treating a fabric with a composition according to the present disclosure. Such methods may provide conditioning and/or freshening benefits.

The method may include a step of contacting a fabric with a fabric conditioning composition of the present disclosure. The composition may be in neat form or diluted in a liquor, for example, a wash or rinse liquor. The composition may be diluted in water prior, during, or after contacting the surface or article. The fabric may be optionally washed and/or rinsed before and/or after the contacting step. The composition may be applied directly onto a fabric or provided to a dispensing vessel or drum of an automatic laundry machine.

The method of treating a fabric may include the steps of: (a) optionally washing, rinsing and/or drying the fabric; (b) contacting the fabric with a fabric conditioning composition as described herein, optionally in the presence of water; (c) optionally washing and/or rinsing the fabric; and (d) optionally drying, whether passively and/or via an active method such as a laundry dryer. The method may occur during the wash cycle or the rinse cycle, preferably the rinse cycle, of an automatic washing machine. The fabric may be treated by a wash cycle and then followed by one or more rinse cycles.

For purposes of the present disclosure, treatment may include but is not limited to, scrubbing and/or mechanical agitation. The fabric may comprise most any fabric capable of being laundered or treated in normal consumer use conditions.

Liquors that comprise the disclosed compositions may have a pH of from about 3 to about 11.5. When diluted, such compositions are typically employed at concentrations of from about 500 ppm to about 15,000 ppm in solution. When the wash solvent is water, the water temperature typically ranges from about 5° C. to about 90° C. and, the water to fabric ratio may be typically from about 1:1 to about 30:1.

The fabric may be contacted with an anionic surfactant, optionally in the presence of water, prior to being contacted with the conditioning composition. The fabric may comprise anionic surfactant that is residual from a washing step. The source of the anionic surfactant may be a detergent composition, such as a heavy duty liquid laundry detergent, a water-soluble pouch comprising a detergent composition, or a powdered laundry detergent. The detergent composition may further comprise suitable detergent adjuncts. For example, the detergent composition may further comprise cellulase enzyme, fatty acids and/or salts thereof, or mixtures thereof.

The anionic surfactant and/or source thereof (e.g., the detergent composition) may be diluted with water in a vessel, such as the drum of an automatic washing machine, to form a wash liquor; the wash liquor may contact the fabric. The method may further comprise removing the wash liquor from the vessel after contacting the fabric, but prior to the fabric being contacted with the conditioning composition.

The conditioning composition may be diluted with water, optionally in a vessel such as an automatic washing machine, to make a rinse liquor. The rinse liquor may comprise anionic surfactant and/or cellulase enzymes, which may be residual or carried-over from a wash cycle. The rinse liquor may be removed from the vessel. The fabric may be dried by any suitable process, such as in an automatic dryer, or by line drying.

The water that is part of the wash liquor and/or the rinse liquor may be characterized by a certain hardness. For example, the water may be characterized by having less than 12 gpg, or less than 10 gpg, of hardness. It is believed that lower levels of hardness can lead to better performance compared to processes that occur in higher levels of hardness.

### Combinations

Specifically contemplated combinations of the disclosure are herein described in the following lettered paragraphs. These combinations are intended to be illustrative in nature and are not intended to be limiting.

A. A fabric conditioning composition comprising: a poly alpha-1,3-glucan ether compound characterized by: (a) a weight average molecular weight of from about 90 kDaltons to about 350 kDaltons, preferably from about 90 to about 300 kDaltons, more preferably from about 90 kDaltons to about 260 kDaltons, more preferably from about 90 to about 240 kDaltons, more preferably from about 95 to about 200 kDaltons, even more preferably from about 100 to about 175 kDaltons, most preferably from about 100 to about 150 kDaltons, and (b) a degree of cationic substitution of from about 0.15 to about 0.8; the fabric conditioning composition further comprising a depositable conditioning active selected from the group consisting of a softening active, a freshness active, or a combination thereof.

B. A fabric conditioning composition comprising: a poly alpha-1,3-glucan ether compound, wherein the poly alpha-1,3-glucan ether compound has a degree of cationic substitution of about 0.15 to about 0.8, preferably from about 0.3 to about 0.7, or from about 0.3 to about 0.6, or from about 0.4 to about 0.6, or from about 0.4 to about 0.5, wherein the poly alpha-1,3-glucan ether compound is derived from a polysaccharide backbone characterized by a weight average molecular weight of from about 90 kDaltons to about 190 kDaltons, as determined prior to substitution; the fabric conditioning composition further comprising a depositable conditioning active selected from the group consisting of a softness active, a freshness active, or a combination thereof.

C. The fabric conditioning composition according to any of paragraphs A or B, wherein the poly alpha-1,3-glucan ether compound is substituted with a substituted ammonium group, preferably a quaternary ammonium group, more preferably a trialkyl ammonium group, even more preferably a trimethylammonium group.

D. The fabric conditioning composition according to any of paragraphs A-C, wherein the poly alpha-1,3-glucan ether compound comprises a backbone that is substantially linear, preferably having fewer than about 10%, or 9%, or 8%, or 7%, or 6%, or 5%, or 4%, or 3%, or 2%, or 1% branch points as a percent of glycosidic linkages in the backbone.

E. The fabric conditioning composition according to any of paragraphs A-D, wherein the poly alpha-1,3-glucan ether compound comprises from about 425 to about 1200 structural units having the following structure:

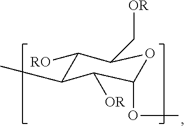

wherein each R is independently an H or a positively charged organic group.

F. The fabric conditioning composition according to paragraph E, wherein the poly alpha-1,3-glucan ether compound comprises from about 500 to about 1100, or from about 600 to about 1050, or from about 700 to about 1000, or from about 700 to about 900, or from about 700 to about 800, of the structural unit.

G. The fabric conditioning composition according to any of paragraphs E or F, wherein each R is independently an H or a positively charged organic group, wherein the positively charged organic group comprises a substituted ammonium group, preferably a quaternary ammonium group, more preferably a trialkyl ammonium group, even more preferably a trimethylammonium group.

H. The fabric conditioning composition according to any of paragraphs A-G, wherein at least one positively charged organic group comprises an alkyl group or hydroxy alkyl group, preferably wherein at least one positively charged organic group comprises a quaternary ammonium hydroxypropyl group.

I. The fabric conditioning composition according to any of paragraphs A-H, wherein the degree of substitution is from about 0.3 to about 0.7, or from about 0.3 to about 0.6, or from about 0.4 to about 0.6, or from about 0.4 to about 0.5.

J. A fabric conditioning composition comprising: a poly alpha-1,3-glucan ether compound represented by the structure:

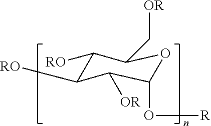

wherein: (i) n is from about 425 to about 1200, preferably from about 500 to about 1100, or from about 600 to about 1050, or from about 700 to about 1000, or from about 700 to about 900, or from about 700 to about 800; (ii) each R is independently an H or a positively charged organic group, preferably wherein the positively charged organic group comprises a substituted ammonium group, preferably a quaternary ammonium group, more preferably a trialkyl ammonium group, even more preferably a trimethylammonium group, and (iii) the compound has a degree of cationic substitution of about 0.15 to about 0.8, preferably from about 0.3 to about 0.7, or from about 0.3 to about 0.6, or from about 0.4 to about 0.6, or from about 0.4 to about 0.5; and the fabric conditioning composition further comprises a depositable conditioning active selected from the group consisting of a softness active, a freshness active, or a combination thereof.

K. The fabric conditioning composition according to any of paragraphs A-J, wherein the poly alpha-1,3-glucan ether compound comprises positively charged organic groups that are trimethylammonium hydroxypropyl groups, preferably where all of the positively charged organic groups are trimethylammonium hydroxypropyl groups.

L. The fabric conditioning composition according to any of paragraphs A-K, wherein the composition comprises from about 0.01% to about 3%, or from about 0.05% to about 2.5%, or from about 0.1% to about 2%, or from about 0.2% to about 1.5%, or from about 0.2% to about 1%, or from about 0.2% to about 0.75%, or from about 0.2% to about 0.5%, by weight of the composition, of the poly alpha-1,3-glucan ether compound.

M. The fabric conditioning composition according to any of paragraphs A-L, wherein the poly alpha-1,3-glucan ether compound is derived from a polysaccharide backbone characterized by a weight average molecular weight of from about 90 kDaltons to about 190 kDaltons, as determined prior to substitution.

N. The fabric conditioning composition according to any of paragraphs A-N, wherein the poly alpha-1,3-glucan ether compound is provided as a premix, wherein the premix comprises from about 5% to about 20%, by weight of the premix, of the poly alpha-1,3-glucan ether compound, wherein the premix further comprises water.

O. The fabric conditioning composition according to any of paragraphs A-O, wherein the depositable active is present at a level of from about 0.1% to about 35%, by weight of the fabric conditioning composition.

P. The fabric conditioning composition according to any of paragraphs A-O, wherein the depositable active comprises a softening active selected from the group consisting of quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof, preferably a quaternary ammonium ester compounds, silicones, or combinations thereof.

Q. The fabric conditioning composition according to any of paragraphs A-P, wherein the depositable active comprises a freshness active selected from the group consisting of free perfume, pro-perfume, a perfume delivery system, malodor control agent, or mixtures thereof, preferably free perfume, a perfume delivery system, or mixtures thereof.

R. The fabric conditioning composition according to paragraph Q, wherein the fabric conditioning composition comprises a perfume delivery system that comprises encapsulates, preferably encapsulates comprising a wall surrounding a core, wherein the wall comprises aminoplast material, polyurethanes, polyureas, polyacrylates, or mixtures thereof, optionally with a coating.

S. The fabric conditioning composition according to any of paragraphs A-R, wherein the fabric conditioning composition is in the form of a liquid composition, preferably a liquid composition that comprises at least 50%, preferably at least 75%, more preferably at least 85%, even more preferably at least 90%, or even at least 95%, by weight of the composition, of water.

T. The fabric conditioning composition according to any of paragraphs A-S, wherein the fabric conditioning composition comprises less than about 5%, preferably less than 3%, more preferably less than 1%, most preferably less than 0.5%, of anionic surfactant, if any.

U. The fabric conditioning composition according to any of paragraphs A-T, wherein the fabric conditioning composition comprises an additional cationic polymer, preferably wherein the additional cationic polymer is selected from a cationic polysaccharide, a cationic acrylate, or mixtures thereof, more preferably wherein the cationic acrylate comprises cationic monomers selected from the group consisting of methyl chloride quaternized dimethyl aminoethylammonium acrylate, methyl chloride quaternized dimethyl aminoethylammonium methacrylate and mixtures thereof.

V. The fabric conditioning composition according to any of paragraphs A-U, wherein the fabric conditioning composition is characterized by a pH of from about 2 to about 4, preferably a pH of from about 2 to about 3.7, more preferably a pH from about 2 to about 3.5.

W. The fabric conditioning composition according to any of paragraphs A-V, wherein the conditioning composition is a liquid characterized by a viscosity of from about from 1 to 1500 centipoises (1-1500 mPa*s), or from 100 to 1000 centipoises (100-1000 mPa*s), or from 100 to 500 centipoises (100-500 mPa*s), or from 100 to 300 centipoises (100-300 mPa*s), or from 100 to 200 centipoises (100-200 mPa*s) at 20 s⁻¹ and 21° C.

X. The fabric conditioning composition according to any of paragraphs A-W, wherein the fabric conditioning composition is in the form of particles, wherein individual particles have a mass of from about 1 mg to about 1 gram, and wherein the particles comprise the poly alpha-1,3-glucan ether compound dispersed in a water-soluble carrier, preferably a water-soluble carrier selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.

Y. A process of conditioning a fabric, the process comprising the steps of: contacting a fabric with the conditioning composition according to any preceding claim, optionally in the presence of water; and optionally rinsing the surface with water.

Z. The process of conditioning a fabric according to paragraph Y, wherein the conditioning composition is diluted in water to form a rinse liquor, the rinse liquor further comprising anionic surfactant and/or cellulase enzyme, the anionic surfactant and/or the cellulase optionally being residual or carried-over from a wash cycle.

### Test Methods

### Preparation of Poly Alpha-1,3-Glucan

Poly alpha-1,3-glucan can be prepared using a gtfJ enzyme preparation as described in U.S. Patent Appl. Publ. No. 2013/0244288, which is incorporated herein by reference in its entirety.

### ¹H Nuclear Magnetic Resonance (NMR) Method for Determining Molar Substitution of Poly Alpha-1,3-Glucan Ether Derivatives

Approximately 30 mg of the poly alpha-1,3-glucan ether derivative is weighed into a vial on an analytical balance. The vial is removed from the balance and 1.0 mL of deuterium oxide was added to the vial. A magnetic stir bar is added to the vial and the mixture is stirred to suspend the solid. Deuterated sulfuric acid (50% v/v in D20), 1.0 mL, is then added to the vial and the mixture is heated at 90° C. for 1 hour in order to depolymerize and solubilize the polymer. The solution is allowed to cool to room temperature and then a 0.8 mL portion of the solution is transferred into a 5-mm NMR tube using a glass pipet. A quantitative ¹H NMR spectrum is acquired using an Agilent VNMRS 400 MHz NMR spectrometer equipped with a 5-mm Autoswitchable Quad probe. The spectrum is acquired at a spectral frequency of 399.945 MHz, using a spectral window of 6410.3 Hz, an acquisition time of 3.744 seconds, an inter-pulse delay of 10 seconds and 64 pulses. The time domain data are transformed using exponential multiplication of 0.50 Hz.

Determination of Weight Average Molecular Weight and/or Degree of Polymerization

Degree of polymerization (DP) is determined by size exclusion chromatography (SEC). For SEC analysis, dry poly alpha-1,3-glucan ether derivative is dissolved in phosphate-buffered saline (PBS) (0.02-0.2 mg/mL). The chromatographic system used is an Alliance™ 2695 liquid chromatograph from Waters Corporation (Milford, Mass.) coupled with three on-line detectors: a differential refractometer 410 from Waters, a multi-angle light-scattering photometer Heleos™ 8+ from Wyatt Technologies (Santa Barbara, Calif.), and a differential capillary viscometer ViscoStar™ from Wyatt Technologies. The columns used for SEC are two Tosoh Haas Bioscience TSK GMPW_{XL} g3K and g4K G3000PW and G4000PW polymeric columns for aqueous polymers. The mobile phase is PBS. The chromatographic conditions used are 30° C. at column and detector compartments, 30° C. at sample and injector compartments, a flow rate of 0.5 mL/min, and injection volume of 100 μL. The software packages used for data reduction are Astra version 6 from Wyatt (triple detection method with column calibration).

### Homogenization

Homogenization is performed using an IKA ULTRA TURRAX T25 Digital Homogenizer (IKA, Wilmington, N.C.).

### Fabric Preparation

To assess performance of a conditioning composition and/or polymer contained therein, fabrics are prepared/treated according to the following method.

A. Equipment and Materials

Fabrics are assessed using Kenmore FS 600 and/or 80 series washer machines. Wash Machines are set at: 32° C./15° C. wash/rinse temperature, 6 gpg hardness, normal cycle, and medium load (64 liters). Fabric bundles consist of 2.5 kilograms of clean fabric consisting of 100% cotton. Test swatches are included with this bundle and comprise of 100% cotton Euro Touch terrycloth towels (purchased from Standard Textile, Inc. Cincinnati, Ohio).

B. Stripping and Desizing

Prior to treatment with any test products, the fabric bundles are stripped according to the Fabric Preparation-Stripping and Desizing procedure before running the test.

The Fabric Preparation-Stripping and Desizing procedure includes washing the clean fabric bundle (2.5 Kg of fabric comprising 100% cotton) including the test swatches of 100% cotton EuroTouch terrycloth towels for 5 consecutive wash cycles followed by a drying cycle. AATCC (American Association of Textile Chemists and Colorists) High Efficiency (HE) liquid detergent is used to strip/de-size the test swatch fabrics and clean fabric bundle (lx recommended dose per wash cycle). The wash conditions are as follows: Kenmore FS 600 and/or 80 series wash machines (or equivalent), set at: 48° C./48° C. wash/rinse temperature, water hardness equal to 0 gpg, normal wash cycle, and medium sized load (64 liters). The dryer timer is set for 55 minutes on the cotton/high/timed dry setting.

C. Test Treatment

Tide Free liquid detergent (lx recommended dose) is added under the surface of the water after the machine is at least half full. Once the water stops flowing and the washer begins to agitate, the clean fabric bundle is added. When the machine is almost full with rinse water, and before agitation has begun, the fabric care testing composition (e.g., the liquid conditioning composition) is slowly added (lx dose), ensuring that none of the fabric care testing composition comes in direct contact with the test swatches or fabric bundle. When the wash/rinse cycle is complete, each wet fabric bundle is transferred to a corresponding dryer. The dryer used is a Maytag commercial series (or equivalent) electric dryer, with the timer set for 55 minutes on the cotton/high heat/timed dry setting. This process is repeated for a total of three (3) complete wash-dry cycles. After the third drying cycle and once the dryer stops, 12 Terry towels from each fabric bundle are removed for actives deposition analysis. The fabrics are then placed in a constant Temperature/Relative Humidity (21° C., 50% relative humidity) controlled grading room for 12-24 hours and then graded for softness and/or actives deposition.

### Secant Modulus Instron Method

The Secant Modulus is measured using a Tensile and Compression Tester Instrument, such as the Instron Model 5565 (Instron Corp., Norwood, Mass., U.S.A.). The instrument is configured depending on the fabric type by selecting the following settings: the mode is Tensile Extension; the Waveform Shape is Triangle; the Maximum Strain is 10% for 479 Sanforized and 35% for 7422 Knitted, the Rate is 0.83 mm/sec for 479 Sanforized and 2.5 mm/sec for 7422 Knitted, the number of Cycles is 4; and the Hold time is 15 seconds between cycles.
1. With scissors, cut serged edge of one entire side of each swatch in the warp direction and carefully peel off strings without stressing the fabric until an even edge is achieved.
2. Place a fabric press die that cuts strips 1″ wide and at least 4″ long parallel to the even edge and cut strips lengthwise in the warp direction.
3. Cut 3 strips of test fabric 479 Sanforized 100% cotton woven or test fabric 7422 50:50 polycotton knitted from 3 separate fabric swatches per treatment. Condition fabrics in a constant temperature (70° F.) and humidity (50% RH) room for at least 6 hours before analysis.
4. Clamp the top and then the bottom of fabric strip into the 2.54 cm grips on the tensile tester instrument with a 2.54 cm gap setting, loading a small amount of force (0.0.05N-0.2N) on the sample.
5. Release bottom clamp and re-clamp sample during the hold cycle, loading 0.05N-0.2N of force on the sample removing the slack by again loading the same force.
6. When 4 hysteresis cycles have been completed for the sample, Secant Modulus is reported in megapascal (MPa). The final result is the average of the individual cycle 4 modulus results from all test strips for a given treatment on a given fabric type. The Secant Modulus reported is calculated at the Maximum Strain for each fabric type.

### Brookfield Viscosity Measurement

Brookfield viscosity is measured using a Brookfield DV-E viscometer. The liquid is contained in a glass jar, where the width of the glass jar is from about 5.5 to 6.5 cm and the height of the glass jar is from about 9 to about 11 cm. For viscosities below 500 cPs, use spindle LV2 at 60 RPM, and to measure viscosities from 500 to 2,000 cPs, use spindle LV3 at 60 RPM. The test is conducted in accordance with the instrument's instructions. Initial Brookfield viscosity is defined as the Brookfield viscosity measured within 24 hours of making the subject composition.

### Method of Measuring Iodine Value of a Quaternary Ammonium Ester Compound

The iodine value of a quaternary ammonium ester fabric compound is the iodine value of the parent fatty acid from which the fabric conditioning active is formed, and is defined as the number of grams of iodine which react with 100 grams of parent fatty acid from which the fabric conditioning active is formed.

First, the quaternary ammonium ester compound is hydrolysed according to the following protocol: 25 g of fabric treatment composition is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric conditioning active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

### Method of Measuring Fatty Acid Chain Length Distribution

The fatty acid chain length distribution of the quaternary ammonium ester fabric conditioning active refers to the chain length distribution of the parent fatty acid from which the fabric conditioning active is formed. It can be measured on the quaternary ammonium ester conditioning active or on the fatty acid extracted from the fabric softener composition as described in the method to determine the iodine value of a quaternary ammonium ester fabric conditioning active. The fatty acid chain length distribution is measured by dissolving 0.2 g of the quaternary ammonium ester conditioning active or extracted fatty acid in 3 mL of 2-butanol, 3 glass beads are added and the sample is vortexed at high speed for 4 minutes. An aliquot of this extract is then transferred into a 2 mL gas chromatography vial, which is then injected into the gas chromatogram inlet (250° C.) of the gas chromatograph (Agilent GC6890N) and the resultant bi-products are separated on a DB-5 ms column (30 m×250 μm×1.0 μm, 2.0 mL/min). These bi-products are identified using a mass-spectrometer (Agilent MSD5973N, Chemstation Software version E.02.02) and the peak areas of the corresponding fatty acid chain lengths are measured. The fatty acid chain length distribution is determined by the relative ratios of the peak areas corresponding to each fatty acid chain length of interest as compared to the sum of all peaks corresponding to all fatty acid chain lengths.

### Volume Weighted Median Encapsulate Size

Encapsulate size is measured using an Accusizer 780A, made by Encapsulate Sizing Systems, Santa Barbara Calif. The instrument is calibrated from 0 to 300μ using Duke encapsulate size standards. Samples for encapsulate size evaluation are prepared by diluting about 1 g emulsion, if the volume weighted median encapsulate size of the emulsion is to be determined, or 1 g of capsule slurry, if the finished capsule volume weighted median encapsulate size is to be determined, in about 5 g of de-ionized water and further diluting about 1 g of this solution in about 25 g of water.

About 1 g of the most dilute sample is added to the Accusizer and the testing initiated, using the autodilution feature. The Accusizer should be reading in excess of 9200 counts/second. If the counts are less than 9200 additional sample should be added. The Accusizer will dilute the test sample until 9200 counts/second and initiate the evaluation. After 2 minutes of testing the Accusizer will display the results, including volume-weighted median size.

The broadness index can be calculated by determining the encapsulate size at which 95% of the cumulative encapsulate volume is exceeded (95% size), the encapsulate size at which 5% of the cumulative encapsulate volume is exceeded (5% size), and the median volume-weighted encapsulate size (50% size−50% of the encapsulate volume both above and below this size). Broadness Index (5)=((95% size)−(5% size))/50% size).

### Freshness Headspace Analysis Method on Fabric

To prepare the fabric for analysis, cut one 2.54 cm×5.08 cm cotton swatches from the cotton terry that is prepared and treated according to the above methods. Place each piece in a 20 mL headspace vial. Re-equilibrated for four hours in a Control Humidity and Temperature room (21 C/50% humidity). After the four hours the vials were capped and analyzed via Headspace solid phase micro-extraction/Gas Chromatography/Mass Spectrometry.

The equipment used for analysis: Gas Chromatograph 7890B equipped with a Mass Selective Detector (5977B) (MSD) and Chemstation quantitation package; Gerstel Multi-Purpose sampler equipped with a solid phase micro-extraction (SPME) probe or similar system; Divinylbenzene/Carboxen/Polydimethylsiloxane SPME fiber from Supleco part #57298-U (or similar fiber); 30 m×0.25 mm nominal diameter, 0.25 μm film thickness, J&W 122-5532UI DB-5; 20 mL

The Gerstel auto sampler parameters are as follows: SPME—from Incubator; Incubation Temperature—65° C.; Incubation Time—10.00 min SAMPLE PARAMETERS; Vial Penetration—22.00 mm; Extraction Time—5.00 min; Inj. Penetration—54.00 mm; Desorption Time—300 s.

The GC oven parameters are as follows for the Front SS Inlet He: Mode—Splitless; Heater—270° C.; GC Run Time—14.28 min. For the Oven: Initial temp.—40° C.; Hold Time—0.5 min; Heating Program—Rate of 17° C./min, Temp of 270° C., Hold Time of 0.25.

The MSD parameters are as follows: Run in scan mode with a minimum range of 35 to 350 m/z; calibration curves are generated from the standards perfume material. quantitation software for each perfume component; Chemstation software (or similar quantitation software) calculates this amount using the quantitation software for each perfume component.

### EXAMPLES

The examples provided below are intended to be illustrative in nature and are not intended to be limiting.

For the formulation examples below, ingredients are identified according to the following key unless otherwise indicated.

| | |
|---|---|
| Fabric Softening Active 1 | N,N-di(alkanoyloxyethyl)-N,N-dimethylammonium chloride |
| | where alkyl consists predominantly of C₁₆—C₁₈ alkyl chains with |
| | an IV value of about 20, available from Evonik |
| Fabric Softening Active 2 | C18 Unsaturated DEEHMAMS (Diethyl Ester Hydroxy ethyl |
| | Methyl Ammonium Methyl Sulphate) from Evonik |
| Amino-functional | As described in US Patent Applications 2011/0243878 and/or |
| Organosiloxane | US2012/0323032 |
| Crosslinked Structuring | Dimethylamino Ethyl Acrylate methochloride (DMA3) + |
| Polymer | Acrylamide (AM) in a 60:40 weight ratio, respectively); 375 |
| | ppm Pentaerythrityl triacrylate/pentaerythrityl tetraacrylate |
| | (PETIA) cross-linker; 0 ppm chain transfer agent. |
| Quaternized | Dimethylamino Ethyl Acrylate methochloride (DMA3) + |
| Polyacrylamide | Acrylamide (AM) in a 60:40 weight ratio, respectively); 10 ppm |
| | Pentaerythrityl triacrylate/pentaerythrityl tetraacrylate (PETIA) |
| | cross-linker; 0 ppm chain transfer agent. |
| FlowsoftFS222 | Available from SNF Floerger |
| Quaternary Ammonium | Details provided for each example |
| Poly alpha-1,3-glucan | |
| Encapsulated Perfume | Perfume encapsulates (melamine-formaldehyde shells, with |
| | deposition aid coating); available from Encapsys, Inc. (Appleton, |
| | Wis., USA) |
| Microcrystalline Cellulose | Microfibrillated cellulose from Borregaard (Norway) |

### Example 1. Preparations of Quaternary Ammonium Poly Alpha-1,3-Glucan

These examples describe producing a quaternary ammonium poly alpha-1,3-glucan ether derivative. Specifically, trimethylammonium hydroxypropyl poly alpha-1,3-glucan was produced.

A. Preparation 1

A 4-neck 1 L round bottom flask containing a metal/mechanical stir rod, thermocouple, addition funnel and condenser with N₂ inlet on top was charged with 130.0 g (0.325 moles) of wet cake glucan (40.5 wt % glucan, DPw800 (˜120,000 MW), milled 180-300 micro, which contains 52.7 g glucan and 77 g water) and 300 mL of isopropanol. The mixture was stirred while 34.6 g of 50 wt % sodium hydroxide solution was added over a 10-minute period (20 to 26° C.). The mixture was stirred at room temperature for 15 min, then heated to 60° C. 3-Chloro-2-hydroxypropyl trimethylammonium chloride (107 g, 60% water solution) was added in 5 min. The reaction was allowed to stir at 58-61° C. for 4 hours. The reaction mixture was very viscous and cooled to about 35° C. and filtered to give a wet cake (try to remove liquid as much as possible by house vacuum and press). The wet cake was mixed with water (3 L) and treated with HCl (18.5 wt %) to bring the pH to about 7. The mixture was filtered to remove any solids. Almost no solids were collected. The filtrate was further purified on TFF (MWCO 30K PES membrane). The retentate was dried to give a solid (71.1 g). Based on NMR, DS is 0.49 of the cationic polyglucan.

B. Preparation 2

10 g of poly alpha-1,3-glucan (M_{w} [weight-average molecular weight]=168,000) was added to 100 mL of isopropanol in a 500-mL capacity round bottom flask fitted with a thermocouple for temperature monitoring and a condenser connected to a recirculating bath, and a magnetic stir bar. 30 mL of sodium hydroxide (17.5% solution) was added dropwise to this preparation, which was then heated to 25° C. on a hotplate. The preparation was stirred for 1 hour before the temperature was increased to 55° C. 3-chloro-2-hydroxypropyl-trimethylammonium chloride (31.25 g) was then added to provide a reaction, which was held at 55° C. for 1.5 hours before being neutralized with 90% acetic acid. The solid thus formed (trimethylammonium hydroxypropyl poly alpha-1,3-glucan) was collected by vacuum filtration and washed with ethanol (95%) four times, dried under vacuum at 20-25° C., and analyzed by NMR and SEC to determine molecular weight and DoS.

Additional samples of trimethylammonium hydroxypropyl poly alpha-1,3-glucan were synthesized following the above process, but with certain process variations. Specifically, poly alpha-1,3-glucan samples with various M_{w}'s were used as starting material, and different amounts of etherification agent (3-chloro-2-hydroxypropyl-trimethylammonium chloride) were used. Also, reaction time (beginning from addition of etherification agent and ending at neutralization) was varied. Table 1 lists these various process variations and the resulting DoS measurements of the quaternary ammonium glucan ether products.

TABLE 1

| | M_{w} of poly alpha-1,3- | Etherification | Reaction | |
|---|---|---|---|---|
| | glucan starting | Agent | Time | |
| Sample | material (Daltons) | Amount | (hours) ^{a} | DoS |
| 1 | 99231 | 31.25 g | 1 | 0.59 |
| 2 | 99231 | 9 g | 1 | 0.39 |
| 3 | 99231 | 9 g | 2 | 0.35 |
| 4 | 99231 | 9 g | 4 | 0.31 |
| 5 | 168000 | 15 g | 2.5 | 0.43 |
| 6 | 189558 | 18 g | 1 | 0.34 |
| 7 | 189558 | 18 g | 2 | 0.37 |
| 8 | 189558 | 18 g | 4 | 0.45 |
| 9 | 163200 | 31.25 g | 3 | 0.52 |

^{a} Reaction time was measured from the time etherification agent was added to the time of reaction neutralization.

### Example 2. Exemplary Liquid Fabric Enhancer

A liquid fabric enhancer can be prepared by mixing ingredients listed in the proportions shown in Table 2. Percentages are by weight of the active ingredient unless otherwise specified.

TABLE 2

| Ingredient | I |
|---|---|
| Fabric Softener Active 1 | 11% |
| Amino-functional Organosiloxane | 3% |
| Crosslinked Structuring Polymer | 0.10% |
| Quaternized Polyacrylamide | 0.064% |
| Quaternary Ammonium Poly alpha-1,3-glucan | 1% |
| Free Perfume | 2.05% |
| Encapsulated Perfume² | 0.20% |
| Water, suds suppressor, stabilizer, | Complete to |
| pH control agent, buffers, dyes | 100% |

### Example 3. Cationic Polyglucans Improve Fabric Secant Modulus

The following tests are run to show that the presence of certain cationic polyglucan compounds can improve performance of a liquid conditioning composition, at two different levels of fabric softening active (8 wt % and 4 wt %).

Fabrics are treated according to the Fabric Preparation method provided above. The liquid conditioning compositions are liquid fabric enhancers according to the formulas shown below in Table 3. Formulas III and V include a cationic polyglucan compound; Formulas II and IV do not, as comparative examples. For each example, 49.5 g/dose of fabric enhancer composition is provided. After treatment, the Secant Modulus of the fabric is determined using an Instron instrument according to the method described above. Results are shown below in Table 3.

TABLE 3

| | II | III | IV | V |
|---|---|---|---|---|
| Ingredient | (comp.) | (inv.) | (comp.) | (inv.) |
| Fabric Softener Active 1 | 8% | 8% | 4% | 4% |
| Crosslinked Structuring | 0.15% | 0.15% | 0.15% | 0.15% |
| Polymer | | | | |
| Quaternary Ammonium | — | 0.48% | — | 0.48% |
| Poly alpha-1, 3-glucan¹ | | | | |
| Perfume | 1.2% | 1.2% | 1.2% | 1.2% |
| Encapsulated Perfume | 0.25% | 0.25% | 0.25% | 0.25% |
| Water, suds suppressor, | Complete | Complete | Complete | Complete |
| stabilizer, pH control agent, | to | to | to | to |
| buffers, dyes | 100% | 100% | 100% | 100% |
| Secant Modulus | 210 MPa | 159 MPa | 232 MPa | 191 MPa |
| (479 Sanforized) | | | | |

¹ Poly glucan ether: Poly alpha-1,3-glucan ether compound according to the present disclosure; SEC (MW) = 140,000; Cationic DoS = 0.5; substituted with trimethylammonium hydroxypropyl groups

As shown in Table 3, the presence of the polyglucan compound decreases the fabric's Secant Modulus, which is typically associated with increased softness.

### Example 4. Effect of Molecular Weight

The following tests are run to show the effect of molecular weight of the cationic polyglucan compound on Secant Modulus values.

Fabrics are treated according to the Fabric Preparation method provided above. The liquid conditioning compositions are liquid fabric enhancers according to the formula shown above in Example 2, and the cationic polyglucan compounds are varied as shown below. For each example, 60 g/dose of liquid conditioning composition is provided. After treatment, the Secant Modulus of the fabric is determined using an Instron instrument according to the method described above. Results are shown in Tables 4A and 4B.

TABLE 4A

| | Polymer Description | | | |
|---|---|---|---|---|
| | SEC | Cationic | Backbone | Secant |
| Example | (MW) | DoS | Type | Modulus |
| 1 | 57,000 | 0.50 | alpha 1,3 | 163 MPa |
| 2 | 78,000 | 0.50 | alpha 1,3 | 155 MPa |
| 3 | 99,000 | 0.51 | alpha 1,3 | 147 MPa |
| 4 | 123,000 | 0.50 | alpha 1,3 | 144 MPa |

TABLE 4B

| | Polymer Description | | | |
|---|---|---|---|---|
| | SEC | Cationic | Backbone | Secant |
| Example | (MW) | DoS | Type | Modulus |
| 5 | 100,000 | 0.41 | alpha 1,3 | 151 MPa |
| 6 | 150,000 | 0.40 | alpha 1,3 | 145 MPa |
| 7 | 242,000 | 0.40 | alpha 1,3 | 164 MPa |

Relatively lower Secant Modulus values are associated with increased softness. Thus, the data in Tables 4A and 4B indicate that polymers according to the present disclosure having a weight average molecular weight of, for example, from greater than 78,000 to less than 242,000 Daltons (preferably from about 99,000 to about 150,000 Daltons) provide improved softness benefits compared to comparative compounds in the tested formulations.

### Example 5. Effect of Degree of Cationic Substitution

The following tests are run to show the effect of the degree of cationic substitution of the cationic polyglucan compound on Secant Modulus values. Polymers of similar molecular weights, but different degrees of cationic substitution (DoS) are selected.

Fabrics are treated according to the Fabric Preparation method provided above. The liquid conditioning compositions are liquid fabric enhancers according to the formula shown above in Example 2, and the cationic polyglucan compounds are varied as shown below. For each example, enough composition is added to provide 9.6 grams of softening active per dose. After treatment, the Secant Modulus of the fabric is determined using an Instron instrument according to the method described above. Results are shown in Table 5.

TABLE 5

| | Polymer Description | | | |
|---|---|---|---|---|
| | SEC | Cationic | Backbone | Secant |
| Example | (MW) | DoS | Type | Modulus |
| 8 | 142,000 | 0.30 | alpha 1,3 | 160 MPa |
| 9 | 150,000 | 0.41 | alpha 1,3 | 151 MPa |
| 10 | 146,000 | 0.49 | alpha 1,3 | 143 MPa |

Relatively lower Secant Modulus values are associated with increased softness. Thus, the data in Table 5 indicate that increasing the degree of cationic substitution (DoS), at least to a point, may provide improved softness benefits in liquid fabric enhancer compositions.

### Example 6. Comparison of Polyglucan Versus Other Polysaccharides

The following tests are run to show relative benefits of a cationic polyglucan compound compared to other cationic polysaccharide compounds.

A liquid conditioning composition having a formula according to Table 6A is prepared, with different cationic polysaccharides as indicated below.

TABLE 6A

| Ingredient | VI |
|---|---|
| Fabric Softener Active 1 | 11% |
| Aminosiloxane Polymer | 3.1% |
| Crosslinked Structuring Polymer | 0.128% |
| Cationic Polysaccharide | 1% |
| (type varies-see below) | |
| Free Perfume | 1.91% |
| Encapsulated Perfume | 0.3% |
| Water, suds suppressor, stabilizer, pH | Complete to |
| control agent, buffers, dyes | 100% |

Fabrics are treated according to the Fabric Preparation method provided above. The liquid conditioning compositions are liquid fabric enhancers according to the formula shown above in Example 2, and the cationic polysaccharides are varied as shown below. A nil-polysaccharide control is also made (Example 11 below). For each example, enough composition is added to provide 3 grams of softening active per dose. After treatment, the Secant Modulus of the fabric is determined using an Instron instrument according to the method described above. Furthermore, the Brookfield viscosity of each liquid conditioning composition is determined according to the method described above. Results are shown in Table 6B.

TABLE 6B

| | | Secant | Viscosity | Viscosity |
|---|---|---|---|---|
| | Cationic | Modulus | Pa-s | Pa-s |
| Example | Polysaccharide | (MPa) | (0.01 s⁻¹) | (0.1 s⁻¹) |
| 11 (comp.) | (none) | (not tested) | 80 | 11 |
| 12 (comp.) | LR400 ¹ | 176 | 437 | 82 |
| 13 (comp.) | Celquat L200 ² | 195 | 188 | 40 |
| 14 | Poly glucan ether ³ | 196 | 55 | 16 |

¹ LR400: Polyquaternium-10; SEC (MW) = 400,000; Cationic DoS = 0.19
² Celquat L200: Polyquaternium-4; SEC (MW) = 303,000; Cationic DoS = 0.45
³ Poly glucan ether: Poly alpha-1,3-glucan ether compound according to the present
disclosure; SEC (MW) = 145,000; Cationic DoS = 0.50; substituted with
trimethylammonium hydroxypropyl groups

The results in Table 6B indicate that a glucan ether compound according to the present disclosure can provide softness benefits (as indicated by Secant Modulus data) similar to those provided by other, known cationic polysaccharides. However, the product viscosity associated with the glucan ether compound is relatively lower than that of the other compositions. The lower viscosity can lead to an improved dispensing experience and less machine residue.

### Example 7. Freshness Examples of Cationic Polyglucans in Liquid Fabric Enhancers

The following tests are run to show that the presence of certain cationic polyglucan compounds can improve freshness performance of a liquid conditioning composition.

Fabrics are treated according to the Fabric Preparation method provided above. The liquid conditioning compositions are liquid fabric enhancers according to the formulas shown below in Table 7. Formula VIII include a cationic polyglucan compound; Formula VII does not, as comparative example. For each example, liquid fabric enhancer is added at a 48.5 grams per dose. After treatment, fabric headspace analysis is performed using a Gas Chromatography instrument according to the method described above. Results are shown below in Table 7.

TABLE 7

| Ingredient | VII | VIII |
|---|---|---|
| Fabric Softener Active 1 | 9.27% | 4.0% |
| Microcrystalline Cellulose | — | 0.06% |
| Crosslinked Structuring Polymer | 0.07% | — |
| Non-ionic surfactant (Tomadol 91-6) | — | 3.26% |
| Quaternary Ammonium Poly alpha-1, 3-glucan¹ | — | 0.5% |
| Free Perfume | 1.53% | 1.53% |
| Encapsulated Perfume | 0.25% | 0.25% |
| Water, suds suppressor, stabilizer, pH control agent, buffers, | Complete to | Complete to |
| dyes | 100% | 100% |
| Normalized Gas Chromatography Headspace @ 50% RH | 1.0 | 1.40 |
| Normalized Gas Chromatography Headspace @ 25% RH | 1.0 | 1.70 |

¹Poly glucan ether: Poly alpha-1,3-glucan ether compound according to the present disclosure; SEC (MW) = 145,000; Cationic DoS = 0.50; substituted with trimethylammonium hydroxypropyl groups

As shown in Table 7, fabrics treated Formulation VIII provide greater amounts of perfume materials in the headspace.

### Example 8. Additional Liquid Fabric Enhancer Examples

Table 8 shows additional illustrative liquid fabric enhancer compositions.

TABLE 8

| Ingredient | IX | X | XI | XII | XIII |
|---|---|---|---|---|---|
| Fabric Softener Active 1 | 5% | 2.5% | 8% | 4% | 2.5% |
| Aminosiloxane Polymer | 2% | 1.5% | — | — | — |
| FlowsoftFS222 | — | — | 0.11% | 0.15% | 0.24% |
| Microcrystalline Cellulose | 5.9% | 5.91% | — | — | — |
| (structurant) | | | | | |
| Quaternary Ammonium | 0.5% | 0.5% | 0.24% | 0.48% | 0.8% |
| Poly alpha-1, 3-glucan | | | | | |
| Free Perfume | 1.68% | 1.56% | 1.20% | 1.20% | 1.20% |
| Encapsulated Perfume | 0.27% | 0.28% | 0.25% | 0.25% | 0.25% |
| Water, suds suppressor, | Complete | Complete | Complete | Complete | Complete |
| stabilizer, pH control | to | to | to | to | to |
| agent, buffers, dyes | 100% | 100% | 100% | 100% | 100% |

### Example 9. Additive Formulations and Softness Benefits

This example shows certain benefits of a cationic polyglucan compound in a solid pastille additive formulation. Fabrics are treated according to the Fabric Preparation method provided above, and the pastille additive is added in the wash cycle. The pastille additive compositions are according to the formulas shown below in Table 9. Formula XV includes a cationic polyglucan compound; Formula XIV does not, as comparative examples. For each example, the pastille additive formulation is added at a 32 g per dose. After treatment, the Secant Modulus is determined using an Instron instrument according to the method described above. Results are shown below in Table 9.

TABLE 9

| Ingredient | XIV (comp.) | XV |
|---|---|---|
| Fabric Softener Active 2 | 30% | 30% |
| PEG¹ | 70% | 67% |
| Quaternary Ammonium Poly alpha-1,3- | — | 3% |
| glucan² | | |
| Secant Modulus (MPa) | 4.93 MPa | 2.98 MPa |
| 7422 Polycotton Blend | | |

¹PEG: Polyethylene glycol (PLURIOL E 8000, ex BASF)
²Poly glucan ether: Poly alpha-1,3-glucan ether compound according to the present disclosure; SEC (MW) = 139,000; Cationic DoS = 0.40; substituted with trimethylammonium hydroxypropyl groups

As shown in Table 9, a fabric treated with Formulation XV provides a relatively lower Secant Modulus value compared to comparative Formulation XIV, indicating improved softness.

### Example 10. Detergent Formulations and Perfume Deposition

This example shows certain benefits of a cationic polyglucan compound in a heavy-duty liquid detergent. More specifically, a cationic polyglucan compound is added to a liquid detergent composition (liquid GAIN®, ex The Procter & Gamble Company); the detergent is then used to treat a fabric. The treated fabric is assessed for average perfume deposition, which is compared to a fabric treated with unmodified detergent.

The average perfume deposition on a fabric is determined as follows. Using an alcohol-based solvent, at a set volume, weighed fabrics are extracted to remove perfume components. The solute is then combined with an internal standard and injected into a GC-MS. Using typical chromatography techniques, perfume peaks are identified and integrated for a quantitative value.

The results are below in Table 10.

TABLE 10

| Example | Detergent Composition | Average Perfume |
|---|---|---|
| | (liquid GAIN ® | Deposition |
| | detergent) | (μg/g of fabric) |
| 15 (comp.) | With no added polyglucan | 6.36 |
| 16 (inv.) | With polyglucan (1wt%)1 | 8.51 |

¹Poly glucan ether: Poly alpha-1,3-glucan ether compound according to the present disclosure; SEC (MW) = 139,000; Cationic DoS = 0.40; substituted with trimethylammonium hydroxypropyl groups

According to the results in Table 1, the liquid laundry detergent that includes a polyglucan according to the present disclosure resulted in relatively increased perfume deposition.

### Example 11. Detergent and Softness

In this example, a commercially available heavy-duty laundry detergent (liquid BOLD® detergent, as sold in Japan; ex Procter & Gamble) is provided. A polyglucan according to the present disclosure is provided to a portion of the detergent. Samples of fabrics are washed with each detergent and scored by a panel for softness. The results are provided in Table 11.

TABLE 11

| | Detergent Composition | Sensory |
|---|---|---|
| Example | (liquid BOLD ® detergent) | Softness Scores |
| 17 (comp.) | With no added polyglucan | 3.09 |
| 18 (inv.) | With polyglucan (0.16 wt %)¹ | 4.18 |

¹Poly glucan ether: Poly alpha-1,3-glucan ether compound according to the present disclosure; SEC (MW) = 139,000; Cationic DoS = 0.40; substituted with trimethylammonium hydroxypropyl groups

According to the results in Table 11, the liquid laundry detergent that includes a polyglucan according to the present disclosure resulted in relatively softer fabrics.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric conditioning composition comprising:
a poly alpha-1,3-glucan ether compound characterized by:
(a) a weight average molecular weight of from 90 kDaltons to 350 kDaltons, and
(b) a degree of cationic substitution of from 0.15 to 0.8; and
a depositable conditioning active selected from the group consisting of a softening active, a freshness active, or a combination thereof,
wherein the softening active, if present, is selected from the group consisting of quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof; and
wherein the freshness active, if present, is selected from the group consisting of free perfume, pro-perfume, a perfume delivery system, malodor control agent, or mixtures thereof.

2. The fabric conditioning composition according to claim 1, wherein the softening active is present and comprises quaternary ammonium ester compounds, silicones, or combinations thereof.

3. The fabric conditioning composition according to claim 1, wherein the poly alpha-1,3-glucan ether compound comprises a backbone that is substantially linear, having fewer than 10% branch points as a percent of glycosidic linkages in the backbone.

4. The fabric conditioning composition according to claim 1, wherein the poly alpha-1,3-glucan ether compound comprises from 425 to 1200 structural units having the following structure: 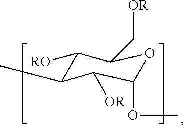
wherein each R is independently an H or a positively charged organic group.

5. The fabric conditioning composition according to claim 1, wherein the poly alpha-1,3-glucan ether compound is substituted with a positively charged organic group that comprises a substituted ammonium group.

6. The fabric conditioning composition according to claim 5, wherein the substituted ammonium group is a trimethylammonium group.

7. The fabric conditioning composition according to claim 1, wherein the poly alpha-1,3-glucan ether compound is substituted with at least one positively charged organic group that comprises an alkyl group or hydroxy alkyl group.

8. The fabric conditioning composition according to claim 7, wherein the at least one positively charged organic group comprises a quaternary ammonium hydroxypropyl group.

9. The fabric conditioning composition according to claim 1, wherein the degree of substitution is from 0.3 to 0.7.

10. The fabric conditioning composition according to claim 1, wherein the composition comprises from 0.01% to 3%, by weight of the composition, of the poly alpha-1,3-glucan ether compound.

11. The fabric conditioning composition according to claim 1, wherein the poly alpha-1,3-glucan ether compound is characterized by a weight average molecular weight of from 90 to 300 kDaltons.

12. The fabric conditioning composition according to claim 1, wherein the poly alpha-1,3-glucan ether compound is characterized by a weight average molecular weight of from 100 to 175 kDaltons.

13. The fabric conditioning composition according to claim 1, wherein the poly alpha-1,3-glucan ether compound is derived from a polysaccharide backbone characterized by a weight average molecular weight of from 90 kDaltons to 190 kDaltons, as determined prior to substitution.

14. The fabric conditioning composition according to claim 1, wherein the poly alpha-1,3-glucan ether compound is provided as a premix,
wherein the premix comprises from 5% to 20%, by weight of the premix, of the poly alpha-1,3-glucan ether compound,
wherein the premix further comprises water.

15. The fabric conditioning composition according to claim 1, wherein the depositable active comprises a perfume delivery system,
wherein the perfume delivery system comprises encapsulates.

16. The fabric conditioning composition according to claim 1, wherein the fabric conditioning composition is in the form of a liquid composition.

17. The fabric conditioning composition according to claim 16, wherein the liquid composition comprises at least 50%, by weight of the composition, of water.

18. The fabric conditioning composition according to claim 1, wherein the conditioning composition is a liquid characterized by a viscosity of from 1 to 1500 centipoises (1-1500 mPa*s), at 20 s⁻¹ and 21° C.

19. The fabric conditioning composition according to claim 1, wherein the fabric conditioning composition is in the form of particles,
wherein individual particles have a mass of from 1 mg to 1 gram, and
wherein the particles comprise the poly alpha-1,3-glucan ether compound dispersed in a water-soluble carrier.

20. A process of conditioning a fabric, the process comprising the steps of:
contacting a fabric with the fabric conditioning composition according to claim 1, optionally in the presence of water; and
optionally rinsing the surface with water.
